(19) United States
(12) Patent Application Publication
(10) Pub. No.: US 2023/0324004 A1
(43) Pub. Date: Oct. 12, 2023

(54) PRESSURE VESSEL LINER, PRESSURE VESSEL AND METHODS

(71) Applicant: XCIENCE LTD, Surrey (GB)

(72) Inventor: Ronald Martin John Kemp, Surrey (GB)

(21) Appl. No.: 18/025,137

(22) PCT Filed: Sep. 9, 2021
(86) PCT No.: PCT/EP2021/074865

§ 371 Date: Mar. 7, 2023

(30) Foreign Application Priority Data
Sep. 9, 2020 (GB) 2014170.1

(51) Int. Cl. F17C 1/08

(52) U.S. Cl. CPC F17C 1/08; F17C 2201/0109; F17C 2201/0123; F17C 2201/056; F17C 2203/013; F17C 2203/0604; F17C 2203/0619; F17C 2203/0673; F17C 2209/227; F17C 2209/221; F17C 2209/232; F17C 2223/036

(57) ABSTRACT

A sectional inner liner of a pressure vessel comprising the sectional inner liner and an outer layer disposed around the sectional inner liner, the sectional inner liner comprising: at least two inner liner sections, wherein each inner liner section comprises an internal network structure; and at least two cap sections, wherein, the at least two cap sections and at least two inner liner sections are configured to assemble into a sectional inner liner.

### FIELD OF THE INVENTION

The present invention relates to an inner liner of a pressure vessel, a pressure vessel including the liner and a method of manufacture of, an inner liner of a pressure vessel, and a conformal pressure vessel.

### BACKGROUND

In recent years, hydrogen has emerged as a promising candidate as a renewable energy source. In particular, its use in the transportation industry has received significant interest because of its inherent advantages over battery technologies. For example, compared to battery technologies, hydrogen storage systems offer faster refuelling times and reduced weight.

Hydrogen can be stored in the solid state using adsorbing or absorbing materials, in the liquid state at cryogenic temperatures, or in the gaseous state under elevated pressure. In the field of mobile applications, amongst other things, a high volumetric and gravimetric energy density are desirable. In solid-state storage devices and liquid state storage devices, temperature management and control systems are often required. These systems add complexity and weight to the system, reducing the effective energy density of the storage system. For this reason, compressed hydrogen gas systems are the preferred choice in industry.

Compressed hydrogen gas systems are stored under extremely high pressure. For example, the ISO14687-2 and ISO12619-1:2014 standard define a gauge pressure of 700 bar. Other defined standard pressures are 300 bar, 350 bar and 500 bar. High pressures naturally result in an improvement in the volumetric and gravimetric energy density of the compressed gas. However, at these elevated pressures, the pressure vessels, containing the compressed gas, require additional reinforcement to ensure that that the vessel is mechanically robust. Often, this reinforcement results in increasing the thickness of the vessel, which leads to an increase in weight and overall volume, which may lead to a reduction in the energy density of the pressure vessel as a whole.

Notwithstanding the fact that hydrogen is extremely flammable, elevated pressures in general pose a significant safety risk. In the field of transportation, this risk is compounded by the proximity of these pressure vessels to passengers. Furthermore, conventional pressure vessels are based on cylindrical or spherical designs, which are cumbersome to handle, and have a tendency to roll. As such, pressure vessel designs of these geometries often require supportive elements to secure the pressure vessels in place.

FIG. 1A shows a conventional pressure vessel 100 known in the prior art. The pressure vessel 100 comprises an inner liner 102 (shown in dashed lines), surrounded by an outer skin 104. The pressure vessel defines a volume 106 for containing gas. FIG. 1B is a sectional view along AA′, which illustrates the double-wall structure in the conventional pressure vessel 100. The inner liner 102 is non-structural and is used as a barrier to contain the gas. The outer skin 104 is structural and is configured to withstand the force of the pressurised gas. The conventional pressure vessel 100 is typically capped at each end with a hemispherical shell. The hemispherical caps are not shown in the Figure. In the development of composite cylinders, the configuration illustrated in FIGS. 1A and 1B is denoted “Type Ill” or “Type IV”. In Type III cylinders, the inner liner 102 is metallic-based. For example, an aluminium or aluminium alloy. The outer skin 104 is typically a diagonally wrapped fibre-reinforced composite. In Type IV cylinders, the inner liner 102 is a thermoplastic. The outer skin 104 is typically a fibre-reinforced composite. Filament winding processes are complex and highly dependent on wrapping angle and winding pattern due to the anisotropic properties of the fibres. A corollary of this method of manufacture is that Type III and Type IV composite pressure vessels are limited to simple geometries such as cylinders or spheres.

US-A-2016061381 discloses a pressure vessel with an internal supportive structure to reduce the pressure applied to the external shell of the pressure vessel. The internal bonds of the supportive structure are mostly connected to a central supporting element. US-A-2016061381 discloses a compartmental or cellular design, which reduces the risk of explosions resulting from external damage to the vessel because the flow capacity is restricted by holes that connect each hole to the central supporting element.

US2006/0261073 discloses a pressure vessel liner, which includes a tubular trunk and head plates to close opposing ends of the trunk. Inside the liner there are reinforcing walls to improve resistant strength against longitudinal forces.

### SUMMARY OF THE INVENTION

According to a first aspect of the present invention, there is provided a sectional inner liner of a pressure vessel comprising the sectional inner liner and an outer layer disposed around the sectional inner liner, the sectional inner liner comprising: at least two inner liner sections, wherein each inner liner section comprises an internal network structure; and at least two cap sections, wherein, the at least two cap sections and at least two inner liner sections are configured to assemble into a sectional inner liner.

The at least two inner liner sections may comprise an interlocking portion at each opposing open-end, which are either the same or complementary in shape; and the at least two cap sections may comprise an interlocking portion, which is either the same or complementary in shape to the interlocking portion of the at least two inner liner section. The cap sections and inner liner sections may therefore be configured to assemble via the interlocking portions. Adhesive bonding and/or welding may be used to secure the interlocking portions in place.

Each inner liner section and cap section may be a single moulding.

The cross-sectional shape of the sectional inner liner, defined by the outer surface of the inner liner section, maybe one of a square or a rounded square. Other shapes are possible.

The internal network structure of the sectional inner liner may comprise: a first set of support members comprising a plurality of first support members, wherein each of the first support members extend across an internal corner of the inner liner section. Optionally further comprising: a second set of support members comprising a plurality of second support members, wherein each of the second support members extend between two of the first support members that extend across adjacent corners of the inner liner section. Optionally further comprising: a third set of support members comprising a plurality of third support members, wherein each of the third support members extends between two adjacent second support members to form a square, or rounded square in cross section. Optionally further comprising: a fourth set of support members comprising a plurality of fourth support members, wherein each of the fourth support members extend radially between a face defined by the internal surface of the inner liner section and a vertex of the square, or rounded square formed by the third set of support members. Optionally, wherein each of the support members in the fourth set of support members bisects one or more of the second support members. Optionally further comprising: a fifth set of support members comprising a plurality of fifth support members, wherein each of the fifth support members extend radially between an internal corner of the inner liner section and one or more of the first support members. Optionally, wherein each of the support members in the fifth set of support members bisects one or more of the first support members.

The internal network structure of the sectional inner liner may be integrally formed within the thickness of the inner liner section wall and optionally, wherein the thickness of the inner liner section wall is largest along its corner edges and smallest along the centre of each of its faces. The variation in thickness of the inner liner section wall may define an internal volume with a shape, in cross section, substantially similar to the outer surface of the inner liner section wall. The internal network structure may comprise one or more holes located along each corner edge of the inner liner section. Optionally, the one or more holes are partially circumferential.

According to a first aspect of the present invention, there is provided a pressure vessel comprising: the sectional inner liner described above and an outer layer disposed around the sectional inner liner.

The outer layer may comprise a woven carbon-fibre cloth infused with resin, or a carbon-fibre winded overwrap.

According to a first aspect of the present invention, there is provided a method for manufacturing the sectional inner liner described above, comprising: injection moulding or casting the at least two inner liner sections and the at least two cap sections; and assembling said sections together. Assembling the sections together may comprise adhesive bonding or welding.

The sectional inner liner may, for example, be produced by additive manufacturing. The sectional inner liner may be represented digitally in the form of a design file. A design file, or computer aided design (CAD) file, is a configuration file that encodes one or more of the surface or volumetric configuration of the shape of the product. That is, a design file represents the geometrical arrangement or shape of the product.

Once obtained, a design file may be converted into a set of computer executable instructions that, once executed by a processer, cause the processor to control an additive manufacturing apparatus to produce a product according to the geometrical arrangement specified in the design file. The conversion may convert the design file into slices or layers that are to be formed sequentially by the additive manufacturing apparatus. The instructions (otherwise known as geometric code or “G-code”) may be calibrated to the specific additive manufacturing apparatus and may specify the precise location and amount of material that is to be formed at each stage in the manufacturing process.

The additive manufacturing apparatus may be controlled according to the computer executable instructions, and the additive manufacturing apparatus may therefore be instructed to print out one or more parts of the inner liner. These may be printed either in assembled or unassembled form. For instance, different sections of the inner liner may be printed separately (as a kit of unassembled parts) and then subsequently assembled. Alternatively, the different parts may be printed in assembled form.

### BRIEF DESCRIPTION OF THE DRAWINGS

Some embodiments of the invention will now be described by way of example only and with reference to the accompanying drawings, in which:

FIG. 1 shows an exemplary pressure vessel known in the prior art;

FIG. 2A shows schematically a perspective view of an exemplary inner liner;

FIG. 2B shows schematically an exemplary internal network structure;

FIG. 3A shows schematically a perspective view of an exemplary pressure vessel;

FIG. 3B shows schematically a plan view of the pressure vessel of FIG. 3B;

FIG. 4 shows simulated results for an exemplary pressure vessel;

FIG. 5 shows an exemplary internal network structure;

FIG. 6A to D show exemplary central portions of internal network structures;

FIG. 7 shows an exemplary conformal pressure vessel;

FIG. 8 shows an exemplary internal network structure.

FIG. 9 shows an exemplary internal network structure.

FIG. 10 shows an exemplary internal network structure.

FIG. 11 shows an exemplary internal network structure.

FIG. 12 shows an exemplary internal network structure.

FIGS. 13A and 13B show a sectional inner liner.

FIGS. 14A and 14B show simulated results for a pressure vessel.

FIG. 15A to 15D show an exemplary internal network structure.

FIG. 16 shows an exemplary internal network structure.

FIG. 17A to 17C show interlocking mating arrangements between inner liner sections.

### DETAILED DESCRIPTION OF PREFERRED EMBODIMENTS

The present invention provides a liner and pressure vessel, which address one or more of the aforementioned problems in the prior art. The present invention also provides a sectional inner liner and sectional pressure vessel.

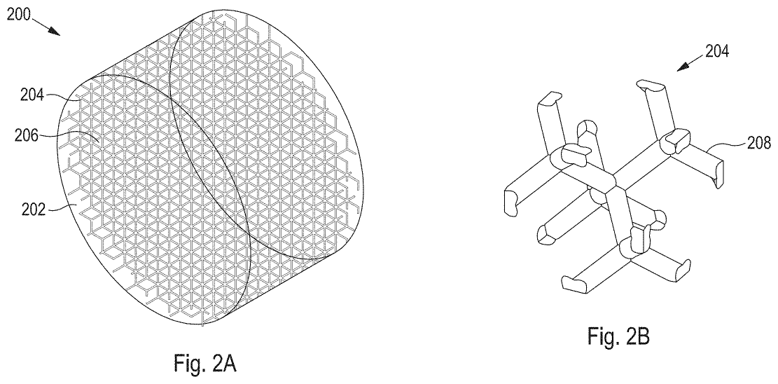

FIG. 2A shows an exemplary inner liner 200 of a cylindrical pressure vessel of the present invention. The inner liner comprises an outer surface 202, which surrounds an internal network of interconnected support members 204, hereafter “internal network” 204. For clarity, in the example illustrated, the end portions of the cylindrical pressure vessel outer surface 202 are not shown.

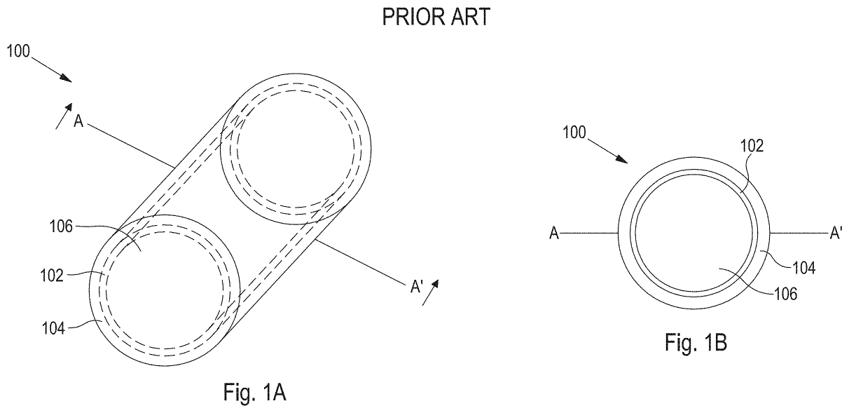

The inner liner 200 of the present invention has plural functions. The outer surface 202 of the inner 200 serves the function of being substantially impermeable to the contained gas in the pressure vessel, while, the internal network structure 204 of the inner liner 200 serves the function of providing support to the pressure vessel walls 202, 302. In this way, the inner liner 200 of the present invention is able to contain pressurised gas and, at the same time, reduces the stress in the pressure vessel walls 202, 302 compared to conventional designs, such as the inner liner of FIG. 1. This result has been verified using a feasibility model, which is described in further detail below.

The internal network 204 of the inner liner 200 and outer surface 202 define a volume 206, which is configured to hold a fluid. Preferably, the volume 206 is interconnected. In some examples, the fluid comprises a pressurised gas, such as hydrogen, nitrogen, oxygen, bio gas, natural gas, ammonia or any other gas, as would be appreciated by the skilled person. In other examples, the fluid comprises a pressurised liquid, such as liquid hydrogen, liquid nitrogen, liquid oxygen, liquid bio gas, liquid ammonia liquid natural gas or any other pressurised liquid, as would be appreciated by the skilled person. For the latter, it is implicit that liquid stored gas can be generated at an arbitrary pressure and temperature, as defined by the corresponding pressure-temperature phase diagram.

The outer surface 202 of the inner liner 200 comprises a material that is configured to contain the contained fluid with only negligible leaking. That is, the material is, practically speaking, impermeable to the contained fluid. For example, if the fluid is pressurised hydrogen gas, then the inner liner is impermeable to hydrogen gas. As such, the function of the outer surface is similar, but not the same, as the inner liner 102 in the conventional pressure vessel.

Preferably, the internal network 204 and the outer surface 202 are integral. That is to say, the internal network 204 and outer surface 202 are formed as a single component. In other examples, the internal network 204 and outer surface 202 may be formed separately and combined in a joining step.

FIG. 2B shows an enlarged section of an internal network of interconnected support members 204, as depicted in FIG. 2A. The internal network 204, as depicted in FIG. 2, is the tetrahedral or diamond cubic lattice structure. With reference to FIGS. 2A and 2B, the internal network comprises, for example, the following characteristics:
a first set of one or more members 208 bonded, or otherwise in permanent mechanical contact, with the outer surface 202 at a first set of contact points;
a second set of one or more members 208 bonded, or otherwise in permanent mechanical contact, with the outer surface 202 at a second set of contact points
wherein the first set and second set of one or more members 208 are bonded, or in permanent mechanical contact, with a third set of one or more members 208, wherein a continuous path exists between the first set of contact points on the outer surface 202 and the second set of contact points on the outer surface 202; and
wherein, the first, second and third set of one or members 208 form a periodic, or quasi-periodic lattice structure.

The internal network structure 204 shown in FIG. 2B is a three dimensional periodic structure based on the tetrahedral (diamond cubic) structure. The form of the periodic structure is not limiting. The inventors envisage that the particular lattice structure of the internal network 204 can be varied depending on operation requirements. The internal network structure 204 can be extended to any form of Bravais lattice. For example, any of: triclinic, monoclinic, orthorhombic, tetragonal, cubic, trigonal and hexagonal. Of these, primitive, base-centred, body-centred and face-centred variations of these structures, where applicable, are all envisaged. In this way, a first type of internal network structure 204 mimics the physical atomic structures known in nature. The support members 208 may be struts, fins, plates, panels, or otherwise, and may include one or more holes. The holes may be through the support member 208, defining an aperture in the support member, or may be holes through the edge of the support member. In the latter, the hole modifies the external share of the support member 208. The length and width of these support members 208 is dependent on the size and geometry of the internal network structure 204, the geometry of the outer surface 202 of the inner line 200, the internal pressure, and the unit cell size. In the example shown, the support members 208 are of dimensions 1 mm and 40 mm.

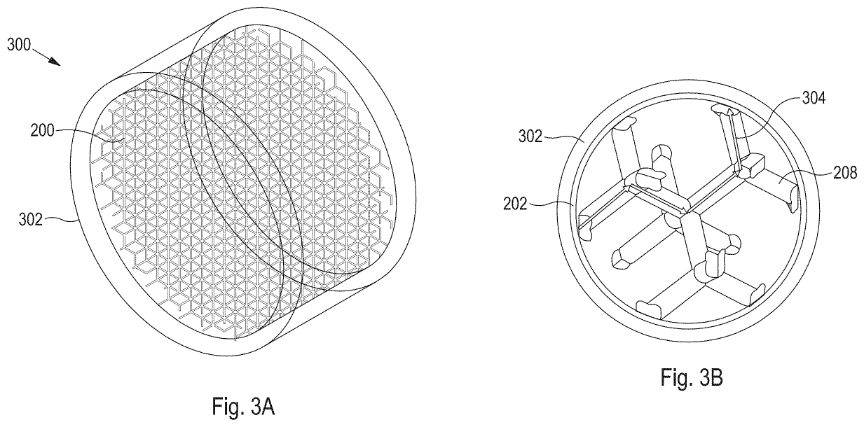

FIG. 3A shows an exemplary pressure vessel 300. The pressure vessel 300 comprises an inner liner 200 housed in an outer skin 302. The exemplary pressure vessel 300 is configured to operate at elevated pressure, such as at 300 bar or more, 350 bar or more, for example, 500 bar or 700 bar or more. Exemplary dimensions of the pressure vessel 300 are: radius of 50 to 250 mm and a length of 250 to 2000 mm.

The internal network of interconnected support members 204 provides structural reinforcement to the pressure vessel 300 which offers a route for increasing the gauge pressure of the pressure vessel whilst, at the same time, potentially improving the gravimetric and/or volumetric energy density of the pressure vessel. In particular, in a hydrogen storage vessel in mobile applications. During operation, or when the pressure vessel 300 is at least partially filled with pressurised gas, the pressurised gas exerts a hydrostatic pressure against the pressure vessel walls 202, 302. Generally speaking, the hydrostatic pressure is larger than the external pressure (pressure outside of the pressure vessel) and therefore acts to force the pressure vessel outwards. According to Newton's third law, in equilibrium, the pressure vessel must exert an equal and opposite force to compensate for this internal hydrostatic overpressure. This restoring force is generated by an elastic strain, which in turn, induces an internal stress in the walls of the pressure vessel 202, 302. This elastic strain, provided that the gauge pressure is greater than zero, is tensile. If the internal pressure increases, the tensile stress in the pressure vessel walls 202, 302 increases until the material comprising the pressure vessel wall 202, 302 fails plastically or otherwise. In the technical field of pressure vessels, especially in containing highly flammable gases such as hydrogen, plastic formation and failure is not an option. For this reason, pressure vessels only operate in the elastic regime and for the remainder of this application, it is implied that the outer skin 302 operates in the elastic regime.

As described above, the internal network 204 comprises a first and second set of one or more members 208 bonded, or otherwise in permanent mechanical contact, with the outer surface 202 at a first and second set of contact points and a continuous path is defined between the first and second set of contact points via mechanical connections with a third set of members 208. In this case, the hydrostatic pressure exerted by the pressurised gas also applies against the internal network 104. For regions of the internal network 204 distal from the outer surface 202 of the inner liner 200 (i.e., where edge effects can be discounted), the internal pressure exerts a hydrostatic compressive stress on the members 208, which form the internal network 204. However, at the same time, the internal pressure exerts a force on the pressure vessel walls 202, 302 to expand and the internal structure 204 must also expand via an elastic strain. Depending on the magnitude of the internal pressure and the structure of the internal network 204, the components of the stress tensor may be in overall tension. In this way, the effective stiffness of the pressure vessel walls 202, 302 increases. Accordingly, the elastic strain induced in the pressure vessel walls 202, 302 decreases as a portion of the elastic strain is “taken up” by the internal network structure 204. In turn, as the stiffness of the pressure vessel walls 202, 302 can be assumed constant (in the elastic regime), the induced stress within the pressure vessels walls 202, 302, for a given internal pressure, decreases. In this way, the internal pressure of the pressure vessel 300 can be increased without increasing the thickness of the outer skin 302.

It is emphasised that in order to induce elastic strain and stress in the members 208 of the internal network structure 204, the members 208 are constrained in some way relative to the outer skin 302 of the pressure vessel. That is to say, there exists a continuous path 304 between at least one point from the first set of contact points on the outer surface 202 of the inner liner 200 and at least one point from the second set of contact points. FIG. 3B depicts (schematically and not to scale) such a path 304. In this way, rather than moving freely with the outer skin 302, the members 208 are able to accommodate strain, and therefore stress, to achieve the desired stress reduction in the outer skin 302 of the pressure vessel 300.

The pressure vessel 300 depicted in FIG. 3A was used in a feasibility study to show the stress reduction principle.

The feasibility study was a simulation in the ANSYS software package. The following assumptions were made:
stiffness remains constant;
linear elastic material model;
no transient or inertial effects are included;
the contact points between the internal network structure 204 and the outer surface 202 and outer skin 302 transfer the loads; and
there is an internal pressure within the pressure vessel (the external pressure is taken as zero, i.e., the pressure is a gauge pressure).

In the feasibility study, the following parameters were taken as constant:
cylindrical pressure vessel with a radius of 0.1 metres;
the length of the cylindrical pressure vessel is 5 “lattice-pattern” units;
the Young's modulus, Poisson's ratio and density of the internal network structure 204 and outer surface 202 are 3.5 GPa, 0.35 and 1150 kgm⁻³ respectively (which is consistent with a thermoplastic);
the Young's modulus, Poisson's ration and density of the outer skin 302 is 90 GPa, 0.05 and 1900 kgm⁻³ respectively (which is consistent with carbon fibre with homogeneous and isotropic properties);
the width of the members 208; and
the internal network structure 204 was modelled as a periodic diamond cubic structure, each repeating unit of the diamond cubic structure defines a “lattice pattern” unit.

In the feasibility study, different configurations of pressure vessel 300 were generated by varying the following parameters:
the length of the members 208;
the thickness of the carbon fibre outer skin 302;
the thickness of the outer surface 202 of the inner liner 200; and
the internal pressure inside the cylindrical pressure vessel 300.

The parametric values for each configuration is shown in Table 1.

TABLE 1

| | Reference ID | | | | | | | |
|---|---|---|---|---|---|---|---|---|
| Parameter | X₀ | X₁ | X₂ | X₃ | X₄ | X₅ | X₆ | X₇ |
| Length of | n/a | 10 | 20 | 10 | n/a | 10 | 20 | n/a |
| member | | | | | | | | |
| [mm] | | | | | | | | |
| Thickness of | 2 | 2 | 2 | 1 | 2 | 1 | 1 | 1 |
| outer skin | | | | | | | | |
| [mm] | | | | | | | | |
| Thickness of | 4 | 4 | 4 | 4 | 2 | 2 | 2 | 4 |
| outer surface | | | | | | | | |
| of inner liner | | | | | | | | |
| [mm] | | | | | | | | |
| Internal | 35 | 35 | 35 | 35 | 35 | 70 | 35 | 35 |
| pressure | | | | | | | | |
| [MPa] | | | | | | | | |

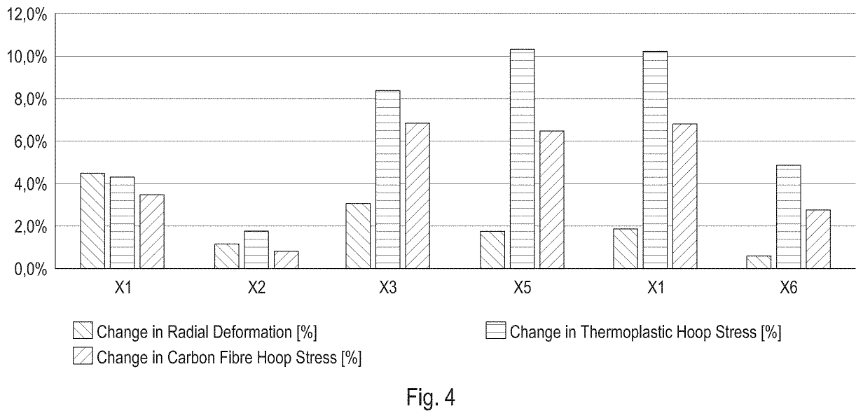

FIG. 4 shows the results percentage stress/strain reductions (y-axis) associated with each configuration relative to X₇. X₇ is a conventional “Type-IV” pressure vessel. The key results are summarised below.
X1 to X3 and X4 to X6: Including an internal network structure reduces the hoop stress in the outer skin 302 and the outer surface 202 of the inner liner 200 and decreases the radial deformation of those elements 202, 302.
X1 vs X2: Increasing the length of the member 208 decreases the stress/strain reduction.
X1 vs X3: Increasing the thickness of the outer skin 302 leads to a reduction in the reduction of the hoop stresses in the outer skin 302 and outer surface 202 of the inner liner 200, but increases the reduction in the radial deformation.
X3 vs X5: Increasing the thickness of the outer surface 202 of the inner liner 200 increases the reduction in hoop stress in the outer skin 302 but decreases the reduction in hoop stress in the outer surface 202 of the inner liner 200. That is, increasing the thickness of the outer surface 202 reduces the hoop stress in the outer skin 302, but increases the hoop stress in the outer surface 202.
X5 vs X5 (70 MPa): In the elastic regime, increasing the pressure does not significantly affect the stress/strain reductions.

The contribution of component mass and volume for each modelled pressure vessel configuration is shown in Table 2 and Table 3.

The calculated maximum radial deformation, and average hoop stresses in the outer surface 202 of the inner liner 200 and the outer skin 302 at 35 MPa gauge pressure are shown in Table 4.

TABLE 2

| | | | Mass of | |
|---|---|---|---|---|
| | Mass of | | internal | Percentage |
| | outer surface | Mass of | network | change in |
| Reference | of inner liner | outer skin | structure | mass relative |
| ID | [kg] | [kg] | [kg] | to X₇ |
| X₀ | 0.334 | 0.287 | 0.000 | 30.189 |
| X₁ | 0.334 | 0.287 | 0.338 | 101.048 |
| X₂ | 0.334 | 0.287 | 0.092 | 49.476 |
| X₃ | 0.334 | 0.143 | 0.338 | 70.860 |
| X₄ | 0.167 | 0.141 | 0.000 | −35.430 |
| X₅ | 0.167 | 0.141 | 0.338 | 35.430 |
| X₆ | 0.167 | 0.141 | 0.092 | −16.142 |
| X₇ | 0.334 | 0.143 | 0.000 | 0 |

TABLE 3

| | Volume | | | | Percentage |
|---|---|---|---|---|---|
| | of outer | | Volume | Volume | change in |
| | surface | Volume | of internal | of gas per | volume of |
| | of inner | of outer | network | unit lattice | contained |
| Reference | liner | skin | structure | length | gas relative |
| ID | [cm³] | [cm³] | [cm³] | [cm³] | to X₇ |
| X₀ | 290.435 | 151.053 | 0.000 | 275.766 | −2.325 |
| X₁ | 290.435 | 151.053 | 293.913 | 250.3124 | −11.340 |
| X₂ | 290.435 | 151.053 | 80.000 | 291.419 | 3.220 |
| X₃ | 290.435 | 75.263 | 293.913 | 256.876 | −9.016 |
| X₄ | 145.217 | 74.211 | 0.000 | 294.997 | 4.487 |
| X₅ | 145.217 | 74.211 | 293.913 | 269.543 | −4.529 |
| X₆ | 145.217 | 74.211 | 80.000 | 301.034 | −6.626 |
| X₇ | 290.435 | 75.263 | 0.000 | 282.330 | 0 |

TABLE 4

| | | | | Percentage | | |
|---|---|---|---|---|---|---|
| | | | Hoop | change of | | |
| | | Percentage | stress in | stress in | Hoop | Percentage |
| | | change of | outer | outer | stress | change of |
| | Radial | radial | surface | surface of | in | stress in |
| Refer- | defor- | deformation | of inner | inner liner | outer | outer skin |
| ence | mation | relative to | liner | relative to | skin | relative to |
| ID | [mm] | X₇ | [MPa] | X₇ | [MPa] | X₇ |
| X₀ | 1.79 | −45.92 | 69.6 | −46.00 | 1610 | −46.03 |
| X₁ | 1.71 | −48.33 | 66.6 | −48.33 | 1554 | −47.90 |
| X₂ | 1.77 | −46.53 | 68.4 | −46.94 | 1598 | −46.43 |
| X₃ | 3.21 | −3.02 | 118.0 | −8.46 | 2779 | −6.84 |
| X₄ | 3.57 | 7.85 | 139.2 | 7.99 | 3220 | 7.95 |
| X₅ | 3.51 | 6.04 | 124.8 | −3.18 | 3012 | 0.97 |
| X₆ | 3.55 | 7.25 | 132.5 | 2.79 | 3132 | 4.99 |
| X₇ | 3.31 | 0 | 128.9 | 0 | 2983 | 0 |

By comparing the results shown in Table 2 to 4 of X1 with X0 and of X3 with X7, the effect of the internal network structure 204 on the gravimetric and volumetric energy density can be determined. For clarity, X0 and X7 denote the conventional type “IV” composite pressure vessels, and X1 and X3 have respectively equivalent physical properties, except they also include the diamond lattice structure of FIG. 2B as an internal network 204 support.

### X1 vs X0

X1 is approximately 70 percentage points heavier than X0. X1 has approximately 9 percentage points less volume 206 for filling with gas than X0. X1 has approximately 2.4, 2.3 and 1.8 percentage point reduction in radial deformation, and hoop stress in the outer surface 202 and outer skin 302 respectively.

### X3 vs X7

X3 is approximately 70 percent heavier than X7. X3 is only capable of storing 91 percent of the volume of gas in X7. The radial deformation, and hoop stress in the outer surface 202 and outer skin 302 are approximately 3, 8.5 and 6.8 percent lower than of X7 respectively.

Accordingly, the results of the feasibility study confirm that the inner liner 200 leads to a reduction in stress and strain induced in the pressure vessel walls 202, 302. However, preliminary results show that, in the exemplary internal network structure 204 shown in FIG. 2B, the reduction in stress and stress does not outweigh the increase in mass and loss in total volume 206 for storing gas. However, it is emphasised that the experimental data is a feasibility study and does not represent optimised design structures. In any case, comparing X3 with X7 shows that a reduction of stress outweighing the decrease the volume is very plausible (cf. 9 percent to 8.5 percent).

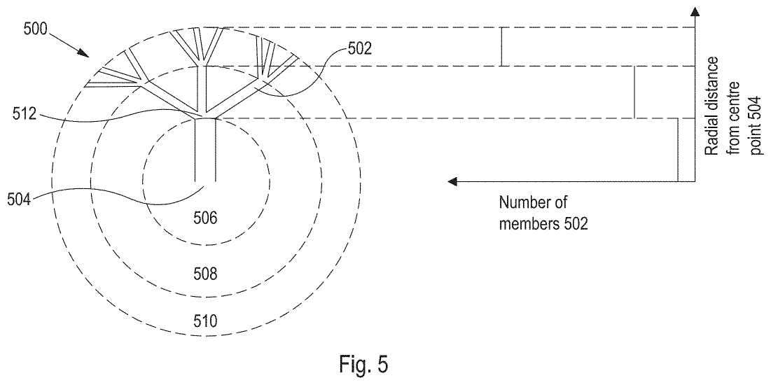

FIG. 5 shows a portion of a non-periodic internal network structure 500. The non-periodic internal network structure biomimetic inspired by fractal structures or “tree-like” structures found in nature, but also include hierarchical or graded structures based on the internal network structures 204 shown in FIG. 2A. In some examples, the non-periodic internal network structure 500 replaces the periodic internal network structure 204 in the pressure vessel 300. In examples where the non-periodic internal structure replaces the periodic internal structure 204 of FIG. 2A, the shape of the outer surface 202 of the inner liner 200 may not necessarily be a cylinder or sphere (but can be). In examples where the outer surface 202 of the inner liner 200 is not a cylinder or sphere, other shapes such as, oblate spheroid, ellipsoid, rounded cuboid or rounded rectangular cuboid. Generally speaking, the non-periodic internal network structure 500 comprises the following characteristics:
a first set of one or more members 502 bonded, or otherwise in permanent mechanical contact, with the outer surface 202 at a first set of contact points;
a second set of one or more members 502 bonded, or otherwise in permanent mechanical contact, with the outer surface 202 at a second set of contact points
wherein a continuous path exists between the first set of contact points on the outer surface 202 and the second set of points on the outer surface 202 and the continuous path comprises one or more nodes 512; and
wherein, the local number density of support members varies along the continuous path. The local number density of support members is defined as the number of support members in a given local volume. The local volume is defined by a spherical volume with radius between one and five support member lengths, where the support member length is the largest dimension of the support member.

The internal network structure 500 comprises a plurality of radially extending support members 502. In some embodiments, the number of the radially extending support members 502 increase with distance from a centre point 504 of the pressure vessel. Nodes 512 in the internal network structure 500 are disposed in the structure for this purpose. In some examples, the centre point 504 of the pressure vessel is the centre of volume 504 of the pressure vessel. In some examples, the centre point 504 is the centre of mass of the pressure vessel. Depending on the overall geometry of the pressure vessel, the centre of mass and centre of volume may be coincident.

In the exemplary internal network structure 500 shown in FIG. 5, the number of the radially extending support members 502 increases in discrete steps, at each node 512 in the internal network structure 500. These discrete steps are shown in the graph adjacent to the exemplary internal network structure 500. This increase in the number of support members 502 at each node 512 defines a multiplication factor. For example, the multiplication factor shown in FIG. 5 is equal to three. The description places no limitation on the magnitude of this multiplication factor. The nodes are separated by a length equal to the length of the support members 502.

At each node 512, the supporting members “generated” by the multiplication factor are separated by an angle. In some examples, the supporting members are spaced evenly in angular space. In an example, if the multiplication factor is four, the angle between each supporting member may be 109.5 degrees.

As shown in FIG. 5, the nodes 512 define discrete volumes 506, 508, 510. In each of the discrete volumes 506, 508, 510, the number density of members is approximately constant. In the example shown, the discrete volumes 506, 508, 510 are circular/spherical. More generally, the discrete volumes 506, 508, 510 may not be circular. In particular, such a condition is imposed if the pressure vessel shape comprises at least one axis of circular symmetry. More generally, the discrete volumes 506, 508, 510 define regions which depend on the overall pressure vessel shape, where the pressure vessel shape may not comprise an axis of circular symmetry. In these cases, the shape of the pressure vessel induces a stress-strain distribution within a “virtual” periodic internal network structure 204. Accordingly, the non-periodic structure defines corresponding volumes 506, 508, 510, which “map out” the areas of increasing stress-strain. In this way, the shape of these discrete volumes 506, 508, 510 more generally resembles the form of the “virtual” stress-strain distribution that would result in a periodic internal network structure 204. These volumes 506, 508, 510 therefore define hierarchical levels in a hierarchical structure of the internal network structure 500. In an example, the number of discrete volumes 506, 508, 510 may be three and the multiplication factor in each volume may be 1, 100 and 1000 respectively. However, the invention places no limits on the number of hierarchical levels or multiplication factor.

In some examples, each volume 506, 508, 510 may comprise essentially a periodic structure internal network structure 204 as shown in FIG. 2. At the boundaries between these volumes (506, 508), (508, 510), the internal network structure may be quasi-periodic. In these examples, the cross section of the support members 502 may vary in each volume 506, 508, 510.

The motivation behind this internal network structure 500 is that the inventors have recognised that the stress and strain induced in the outermost support members 208 in a periodic internal network structure 204 is larger than the stress and strain induced in the more inner members 208. This is caused at least in part by the formation of local stress concentrations that form at the contact points between the support members 208, 502 and the outer surface 202 of the inner liner 200. Accordingly, in the structure shown in FIG. 5, the number of contact points at the outer layer 202 of the inner liner 200 is increased by using nodes 512 with a multiplication factor of greater than one. The increase in the number of contract points at the outer surface 202 of the inner liner 200 reduces stress concentrations that form because the load is spread over a larger total area. Furthermore, in the internal network structure 500 of FIG. 5, the increased number of immediately surrounding support members 502 means that more local stress and strain can be accommodated away from the high stress-strain contact points. In this way, the “virtual” stress concentration profile is flattened in the non-periodic internal network structure 500 shown in FIG. 5.

In this light, increasing the number density of the support members 502 in regions proximal to the outer surface 202 of the inner line 200 is a way of reducing stress concentration in these regions. Graded or hierarchical structures are a way of achieving this. In a graded structure, the number density of the support members may be varied continuously throughout the internal network structure. In hierarchical structures, the number density of the support members may be varied in discrete steps in the internal network structure. Generally speaking, a variation in number density of the support members can be adopted to accommodate for high stress regions where failure is most likely to occur. The number density can be varied in a number of different ways to generate either a graded or a hierarchical structure.

As alluded to above, an option for increasing the number density of support members is to include nodes with a multiplication factor of greater than one. A gradient in the number density of support members can then be generated by increasing the multiplication factor with increasing distance from the centre point 504. In this way, a “tree-like” structure results whereby the support members 502 (branches) become increasingly complex and finely distributed. Another option is to reduce the length of the support members 502, which decreases the distance between adjacent nodes, thereby increasing the local node density. By decreasing the length of the support members with increasing proximity to the outer surface 202 of the inner liner 200, a gradient in the number density of support members can be generated. Phrased differently, reducing the length of the support members 502 increases the number of nodes and therefore points for branching that can arise between the centre point 504 and the outer surface 202 of the inner liner 200. Another option is to increase the node density. Another option is to increase the angle between adjacent support members 502 that emerge from a given node 512. By varying this angle, the number of nodes points from the centre point 506 and outer surface 202 of the inner liner 200 increases because the continuous path that the support members 502 define is longer and more convoluted. These options (in the preceding paragraph) also increase the local support member density. In addition, the cross section (width and/or height) of the support member 502 may be varied to generate a gradient in the local support member density. This option can be used to generate a graded structure in a periodic internal network structure 204. In some examples, a gradient in local support member density may be generated by decreasing the cross-section of the support members 502 towards the outer surface 202 of the inner liner 200. Any of the above options for increasing the number and/or local support member density may be combined in any combination. For example, if the support member 502 cross section decreases proximal to the outer surface 202 of the inner liner 200, then the node density may accordingly be increased proximal to that surface 202.

It is proposed that a stress concentration profile, at the contact points between the support members 208 and the outer surface 202 of the inner liner 200, exists in the internal network structure 204, 500. Accordingly, in periodic internal network structures 204, failure is most likely to occur at these locations of stress concentration (the contact points with the outer surface 202 of the inner liner 200). Therefore, the interior regions of the internal network, at a lower overall stress, are less likely to fail. The interior regions of the internal network structure are therefore, at least partially, structurally redundant. By adopting a graded or hierarchical structure, some of this structural redundancy can be removed. This could lead to potential improvements in both volumetric and gravimetric energy densities of the pressure vessel 300. Improvements in volumetric and gravimetric energy densities of stored gas, such as compressed hydrogen are desirable in the field of mobile applications, such as for hydrogen powered vehicles. The graded or hierarchical structures defined above may be particularly effective in improving these energy densities.

In general, the stress-strain distribution may be a function of at least the following factors: the variation of the number density or volumetric density (the local density) of support members; the length of the support members 208, 502; the cross section (width and height) of the support members 208, 502; and the geometrical shape of those support members 208, 502 relative to the shape of the outer surface 202.

In summary, using a hierarchical or graded structure has at least the following possible advantages over a periodic structure such as that shown in FIG. 2A:
a reduction in the stress concentrations at the contact points with the outer surface 202 of the inner liner 200 (by distributing the load over a larger area of the outer surface 202 and locating a greater proportion of support members 502 in proximity to these high stress regions);
a potential reduction in the mass of the overall internal structure 500 (by eliminating structural support members 202 in the innermost volumes 506, 508);
a potential increase in the total volume of gas that can be stored at a given pressure (by eliminating, or, reducing in volume structural support members 202 in the innermost volumes 506, 508).

In other examples, the “virtual” stress-strain distribution may also be “flattened” at the outer edges of the internal network structure 204, 500 of the inner liner 200 by spatially varying the stiffness, or other mechanical property, of the material comprising the internal network structure 204, 500. Just as the number of support members 502 is increased towards the outer surface 202 of the inner liner 200 in FIG. 5 to increase the effective stiffness of the internal structure 500 in proximity to these regions, the stiffness of the internal structure 500 can also be controlled by spatially varying the material comprising the network 500. That is, the core volumes 506, 508, 510 may each comprise a material with a given compliance. The compliance between the core volumes 506, 508, 510 may vary—increasing towards the outer surface 202. It is envisaged that such compliance-graded structures could be used in combination with either the periodic or the non-periodic graded or hierarchical internal structure 204, 500 configurations. This variation in material stiffness throughout the internal network structure 204, 500 may also lead to further improvements in volumetric and gravimetric energy density for stored gases.

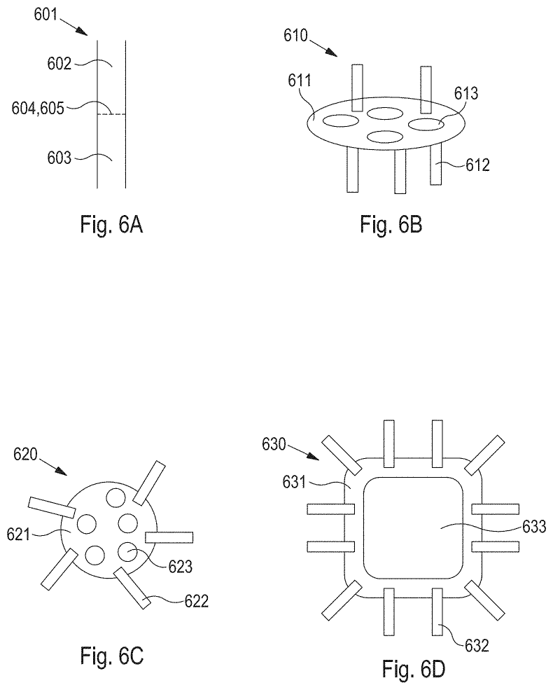

FIG. 6A to 6D show exemplary structures at the centre point 504 of the pressure vessel for providing one or more of the non-periodic structures 500 illustrated in FIG. 5. Similarly, each of the resulting periodic structures 500 is envisaged to replace the periodic structure 204 in the inner liner of FIG. 2.

In FIG. 6A, the central portion 601 of the non-periodic internal network structure 500 comprises a connecting plane 605 between a root 602 of a first non-periodic structure 500 and a root 603 of a second non-periodic structure 500. Generally speaking, the root of a non-periodic structure 500 is the point, or support member 502, in which all the connection paths created by the support members 502 can be defined from. In some examples, the connecting plane 605 is formed by a mechanical abutting the root 602 of the first non-periodic structure with the other root 603 and defines a bonding interface. In other examples, the first and second non-periodic structures comprises an integral component and the connecting plane 605 defines the intersection of the roots 602, 603. In these configurations, the connecting plane may define a plane of symmetry if the first and second non-periodic structures are the same. In other examples, the non-periodic structures comprising the roots 602, 603 may not be the same.

In FIG. 6B, the central portion 610 of the non-periodic internal network structure 500 comprises a disc, or plate 611, in which one or more roots 612 of non-periodic network structure 500 are mechanically connected to, or abut against. In some examples, the roots 612 and disc 611 are an integral component. In other examples, the roots 612 comprising the non-periodic structures 500 and discs 611 are fabricated separately and joined together in a mechanical joining process. In some examples, the disc 611 also comprises one or more holes 613. These holes reduce the total mass of the central portion 610 and increase the total volume for containing gas.

In FIG. 6C, the central portion 620 of the internal network structure 500 comprises a sphere 621, cylinder or oblate spheroid, in which one or more roots 622 are mechanically connected to, or abut against. In some examples, the roots 622 and sphere 621 are an integral component. In other examples, the roots 622 comprising the non-periodic structures 500 and spheres 621 are fabricated separately and joined together in a mechanical joining process. In some examples, the sphere 621 also comprises one or more holes 623. These holes reduce the total mass of the central portion 620 and also increase the total volume for containing gas.

It is envisaged that other shapes of central portion 610, 620 are possible. For example, ellipsoids or variants of cylinders. Such generic variations in the shape of the central portion 610, 620 are all within the scope of the knowledge of the skilled person.

In FIG. 6D, the central portion 630 of the internal network structure 500 comprises a toroid, or ring-shaped central support member 631, in which one or more roots 632 are mechanically connected, or abut against each other. In some examples, the roots 632 and the central support member 631 are an integral component. In other examples, the roots 632 comprising the non-periodic structures 500 and central support member 631 are fabricated separately and joined together in a mechanical joining process. As illustrated, the ring-shape central support member 631 defines a ring aperture 633. This hole reduces the overall mass of the central portion and increases the surface area to volume ratio for roots 632 to mechanically bond or abut with the central portion 630.

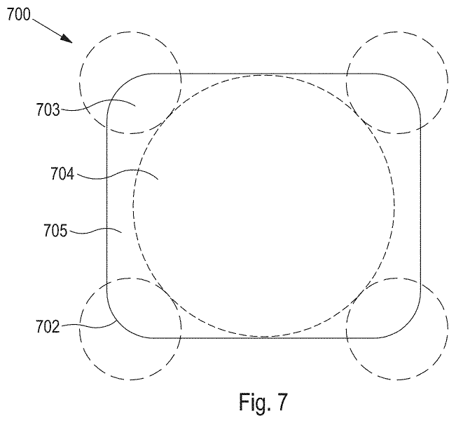

FIG. 7 shows an exemplary conformal pressure vessel 700. A conformal pressure vessel 700 may be a general shape designed to fit a required space. That is to say, conventionally, the shape of the pressure vessel is fixed to a cylinder or sphere. However, in a conformal pressure vessel 700, the shape is a parameter that can be controlled and it is envisaged that it may be fixed by the space in which the pressure vessel is intended to reside during operation. For example, in the technical field of mobile applications, the conformal pressure vessel can be designed to fit an arbitrary space in a vehicle. In some examples, the conformal pressure vessel 700 may be cylindrical or spherical, but this is dependent on the available space in the operating environment. The pressure vessel 700 comprises an outer skin 302 and an inner liner 200. The inner liner 200 comprises a non-periodic internal network structure 500, with any of the central portions 601, 610, 620, 630 defined in FIG. 6A-D. In such examples, the outer surface 202 of the inner liner 200 has a shape, which substantially corresponds to the shape of the outer skin 302. As described above, the inner liner 200 contains the pressurised gas with a substantially impermeable outer surface 202 layer, and reduces the stress in the outer skin 302 of the pressure vessel 300 with the structural design of the internal network structure 500. The exemplary conformal pressure vessel is configured to operate at elevated pressure, e.g., at 300 bar, 350 bar, 500 bar or 700 bar. Exemplary dimensions of the conformal pressure vessel 700 are width, length and height of 50 to 2000 mm. The overall width, length and height of the conformal pressure vessel 700 may be defined by a particular use case, e.g., the available space in a vehicle. In some cases, the method of manufacture may also constrain the overall size of the pressure vessel 300, 700. For example, in some additive manufacturing methods, the physical size of the component may be limited by the physical size of the equipment, or the physical size of the working area. For example, in stereolithography methods such as photopolymerisation (e.g., Vat photo-polymerisation), where conventional systems are constrained in volume to the size of the resin reservoir or vat. For this reason, large pressure vessels 300, 700 with dimensions greater than 500 mm, may require manufacturing by conventional methods, such as injection moulding.

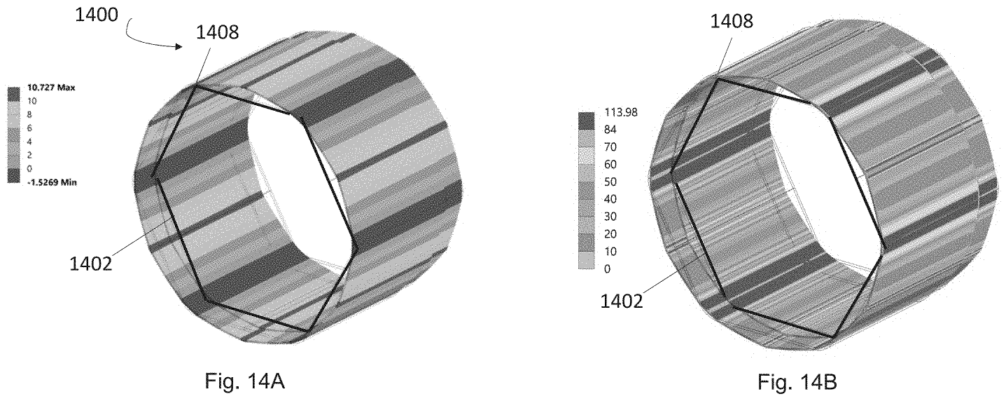

By using non-periodic internal network structure can accommodate stress concentrations, non-conventional shaped pressure vessels 700 are possible. These non-conventional shaped pressure vessels 700 may therefore be tailored to operating environment requirement and so, the pressure vessels 700 can be conformal. Conventional wisdom of the skilled person teaches against including “corner-like” 702 features, which act to introduce unacceptable stress concentrations that would lead to catastrophic failure. However, as described above, the non-periodic internal network structure can accommodate these stress concentrations and allow conformal pressure vessels, which may include pressure vessels with irregular shapes, for example to fit into the internal space of a vehicle. As described above, increasing the number density of support members 502 in proximity to these regions of high stress can accommodate for this stress concentration. Generally speaking, these stress concentrations are located around regions of lowest effective radius of curvature. As such, increasing the number density of support members 502 in proximity to regions of lower effective radius of curvature is a plausible route to mitigate the effects of stress concentrations. However, the stress concentrations may, as for example shown later in FIG. 14B, develop on other portions of the inner liner surface (which may not have a low effective radius of curvature). For example, at the centre of each face. These maxima in stress arise from stress and strain modes which develop in an inner liner of non-circular cross section (e.g., via bending stresses, hoop stresses, tensile stresses concentrations). The support provided by the internal network structure may be greater to these regions of higher stress. The exact location of these regions of high stress/strain depends on the shape of the inner liner in cross section. The support structure is configured to alleviate these areas of stress concentration by distributing part of the stress/strain within the internal network structure. For example, via control of the local stiffness or increasing the number density of members in the support structure in proximity to these regions of higher stress (or by any other manner described herein). In this way, the maximum stress and strain in these regions may be reduced by redistributing stress within the internal network structure.

By definition, a cuboid containing a cylindrical pressure vessel necessarily is larger in volume. An additional volume for containing pressurised gas is therefore available for cuboidal conformal pressure vessels 700. In practice, the corners of the pressure vessels 700 may be rounded to reduce stress concentrations, which reduces the overall increase in volume. However, the increase in volume afforded to cuboidal shaped conformal pressure vessels is not negligible. By way of example, a rectangular cuboid with cross section of nominal length 1 by 1, and nominal length of 3 is able to contain 38% more volume than the largest cylindrical pressure vessel, capped with hemispherical shells at each end, which fits inside that cuboid. These conformal pressure vessels therefore provide a plausible way to increase the gravimetric and volumetric energy densities of the pressure vessel in the technical field of energy storage.

The internal network structure 204, 500 may also improve safety in the case of catastrophic failure, e.g., during a vehicle crash. In conventional pressure vessels 100, if the outer skin 104 is compromised, the pressurised gas is rapidly released from the vessel in an explosion. This rapid release generates very large forces, which act on the pressure vessel, often causing the pressure vessel to become mobile. In effect, the pressure vessel acts as a ballistic. However, in a pressure vessel with an internal network structure 204, 500, the release rate of the pressurised gas is reduced because the volume contained within the internal network structure is interconnected and defines a convoluted path, acting to reduce the release rate of the pressurised gas. In this way, the gas is released more slowly from the compromised pressure vessel. By increasing the overall time in which gas is released, the overall force generated in this process can be decreased and the pressure vessel is less likely to cause damage. Furthermore, in catastrophic failure events, the fracture mechanism in a conventional cylindrical pressure vessel differs from pressure vessels 300, 700 described in this application. In conventional cylindrical pressure vessels, the fracture surface in the outer skin 104 is usually directly along the longitudinal axis of the vessel, and propagation of the fracture surface is rapid. This occurs in a single explosive event. Conversely, in a pressure vessel with an inner liner 200 comprising an internal network structure 204, 500, failure occurs in more controller manner—in sequential stages, where gas is released. Just as a car crumple zone dissipates energy by plastic deformation, the internal network structure 204, 500 acts to dissipate some of the stored elastic/plastic energy in the outer skin 302 after initial fracture occurs. In this way, fracture propagation is slower (possibly even stable, as the pressure in the vessel is released) and the energy released per sequential fracture “event” is lower than in the conventional case. This therefore provides a further safety improvement of the inner liner of the present invention.

Conformal pressure vessels have at least the following advantages over conventional cylindrical or spherical pressure vessels:
reduced tendency to roll;
do not require additional support structures or housings to prevent such rolling;
potential increase in gravimetric energy density (taking into account the support structures);
potential increase in volumetric energy density (taking into account the support structures);
capability for space-efficient stackable configurations;
capability for bespoke designs to “conform” to restricted space requirements; and
potential for improved safety under catastrophic failure (e.g., crash event)

Generally speaking, the internal network structure in the conformal pressure vessel 700 is graded. In other examples, the grading may be in discrete steps, defining a hierarchical structure. The number density, angle, width, length and geometry of the support members 502 in regions 703 proximal to the corner-like 702 features is different to that of regions 704 more distal from such features 702. It is envisaged that a third region between these regions 702, 703 could be used to ensure that these regions 702, 703 “match up” if necessary. These regions may define the hierarchical levels of the hierarchical system. In some examples, there may be a continuous variation in the aforementioned properties across the regions 702, 703. In other examples, the aforementioned properties are constant in regions 702, 703 and a connecting region between these regions 702, 703 connects the two together which comprises the continuous variation instead.

In some examples, the location of the roots 612, 622 are disposed on the central portion disc/sphere 611, 621 to direct the hierarchical non-periodic structure towards the region 702 of local higher stress/strain.

It is envisaged that these regions 703, 704 are defined by stress thresholds. That is, the stress distribution in a “virtual” periodic structure 202 for a given gauge pressure can be calculated. Portions of the “virtual” periodic structure that are above a stress greater than a given threshold define region 703. In some examples, the stress may be the Von Mises stress or Tresca stress and the threshold is the yield stress of the material comprising the “virtual” periodic structure 202. Furthermore, if the stress is below a second threshold (e.g., a predetermined fraction of the yield stress), then this may define another region. In some examples, the stress in region 704 is lower than the first threshold. In other examples, the stress in region 704 is lower than the first and second threshold. According to these defined regions of stress, the structure of the non-periodic structure 500 can be modified to better accommodate for this higher stress. For example, the inventors envisage that the non-periodic structure 500 can be adopted to achieve this effect. The exact form and structure of the non-periodic structure 500 can be optimised by iteratively calculating these stress regions 703, 704 and adapting the structure accordingly. It is envisaged that the optimisation will be to be minimise the mass or volume for a given external shape and gauge pressure.

Referring to FIG. 7, the non-circular cross section of the conformal pressure vessel defines a further region 705, which is an additional volume that can be filled with pressurised gas compared to conventional circular cross section pressure vessels. In conventional designs, region 705 would correspond to a support structure that does not contain gas. As such, the conformal pressure vessel 700 leads to a potential improvement in volumetric energy density.

It will be evident to the skilled person that there are potentially an infinite number of possible internal network structures 204 and that the “actual” design that will be accommodated is a complex function depending on the operating conditions, environment, manufacturing route and the commercial cost of these routes. It is impractical to cover all of these in writing because they are necessarily variable. The general purpose and effect of the internal network structure 204 has been described in detail above, and the skilled person, in view of this document, would appreciate that the specific designs shown are not limiting.

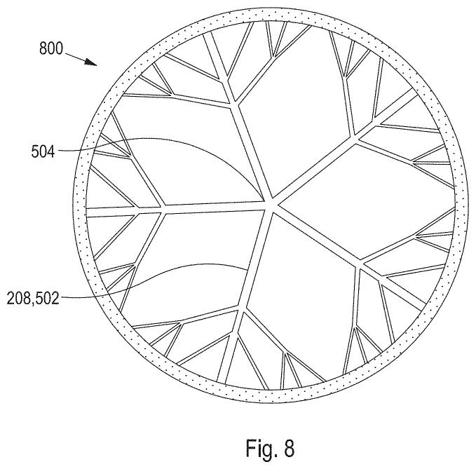

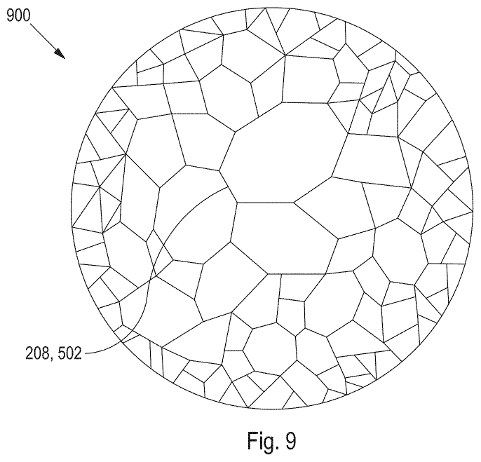

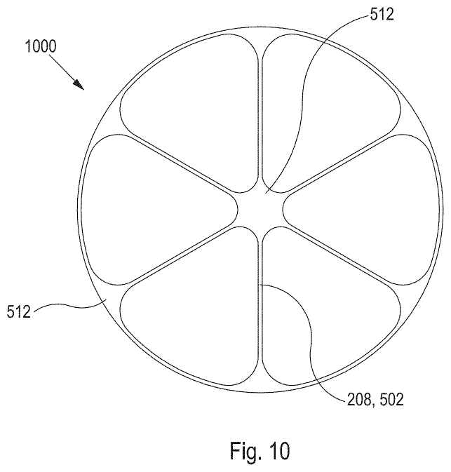

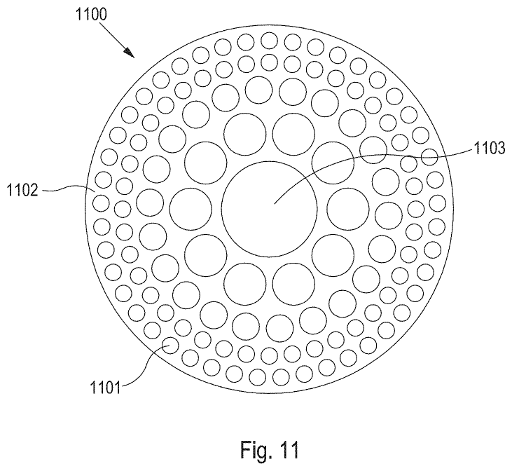

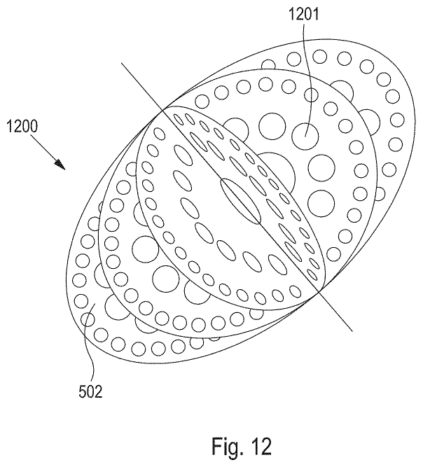

FIGS. 8 to 12 show some further exemplary internal network structures 800, 900, 1000, 1100, 1200. In some examples, the exemplary internal network structures 800, 900, 1000, 1100, 1200 illustrated in these Figures only represent a portion of the internal network structure. Generally speaking, the internal network structures 800, 900, 1000, 1100, 1200 may be larger in the radial sense by extending the corresponding pattern of the internal network structure 800, 900, 1000, 1100, 1200.

The internal network structure 800, 900 are modifications of the internal network structure 500. In these non-periodic structures, the support member density increases in regions proximal to the outer surface 202 of the inner liner 200. In internal network structures 800, 900 the support member density increases by varying the length of the support member 502. In this way, convoluted, interconnected structures can be generated. The internal network structure 900, in particular, illustrates the effect of reducing the length of the support member 502 on the local density of the support members. As shown in these structures 800, 900, the local density of the support members increases with increasing proximity to the outer surface 202 of the inner liner 200. Or equivalently, increases with distance from the centre point 504 of the inner liner.

In exemplary internal network structure 1000 the support members 502 are reinforced at each node 512. The motivation behind the reinforcements at each node 512 is to prevent premature failure at these nodes 512. It is evident that each node connects one support member 502 of a given stress state with another 502, and therefore the nodes 512 may be under a more complex and large overall stress state (Von Mises stress). By reinforcing the support members 502 in the internal network structure 1000, larger stresses can be accommodated by these nodes 512. Some of the nodes 512 may be in contact with the outer surface 202 of the inner liner 200. In some examples, the reinforcement may comprise varying the thickness and/or width of the support members can be adopted in any of the other internal network structure 204, 500, 800, 900 described above. In other examples, the material comprising the reinforced node regions may be stiffer and/or have a larger yield stress than the remainder of the support member 502. The material of the reinforced node region may therefore be different, or, may comprise a different fraction of reinforcing filler in these regions.

The internal network structure 1100 is an alternative example to the network structures 204, 502, 800, 900, 1000, 1200. In this example, the interconnected volumes 206 are defined by a series of “bubbles” 1101, or interconnected holes in an internal body 1102, rather than being defined by the support members 502. The bubbles 1101 are formed within an internal body 1102. The internal body 1102 can replace the internal network structure 204 in FIG. 2. These “bubbles” 1101 may form a lattice arrangement, such as any of the Bravais lattice structures described above. That is, the bubbles 1101 are periodically arranged and effectively located at the lattice points of the Bravais lattice. In some examples, the bubbles are interconnected by additional bubble channels (not shown in Figure). In other examples, the internal body 1102 may be substantially porous to the pressurised gas. For example, hydrogen gas, being the smallest gaseous molecule, may diffuse through the porous internal body 1102 relatively unhindered. Alternatively, the “bubbles” 1101 may form non-periodic structures or graded structures, which may be incorporated into conformal pressure vessels 700. In these examples, the local volume density of the bubbles may decrease in proximity to the outer skin 302 of the conformal pressure vessel 700 to accommodate for the stress concentrations in this regions. For example, in regions 703 shown in FIG. 7. More generally, the local volume density may vary continuously or discretely in steps within the internal body 1102, starting from the centre point 1103 of the internal body to regions proximal to the outer skin 302. In yet more examples, the local bubble density may be substantially uniform, or pseudo-random.

The bubble internal network structures 1100 have one or more of the following characteristics:
an internal body 1102, comprising one or more holes 1101;
the one or more holes 1101 define a volume;
the volume is configured to contain pressurised gas, and the gas is either able to pass from one bubble to another via a diffusional process through the internal body, or, through one or more interconnecting channels between the one or more holes 1101.

In some examples, the internal network structure 1100 may comprise a foam-like structure. The foam-like structure may preferably be open-celled. That is, each of the one or more bubbles 1101 in the internal network structure 1100 are interconnected.

The internal network structure 1200 is another exemplary support structure design. The internal network structure 1200 comprises one or more radially extending support members 502, which comprises one or more holes 1201. These holes 1201 ensure that the volume of gas contained between the support members 502 are interconnected. In some examples, the radially extending support members 502 may be a fin, plate, strut or panel. Any of the central support structures of FIG. 6 may be combined with this type of internal network structure.

In any of the internal network structures 204, 500, 800, 900, 1000 described above, an optimised structure can be determined using at least one or more of the following procedural steps. The optimised structure may maximise the gravimetric energy density, volumetric energy density or the mass of the pressure vessel for a given gauge pressure. In the example below an iterative method is adopted for minimising the mass of an optimised internal network structure.
1) Define the operating conditions and environment, including the operating gauge pressure and the overall shape and dimension of the pressure vessel.
2) Define the shape of the support member 208. In some examples, this may be a strut, fin, plate, panel, or otherwise, and may include one or more apertures.
3) Define the size of the support member 208. Define a thickness of the outer skin 302 of the pressure vessel and a thickness of the outer surface of the inner liner 200. This thickness can be set in advance depending on the cost of these components relative to the cost of the internal network structure 204. The thicknesses should be less than the corresponding thicknesses in a corresponding conventional pressure vessel 100 at the same operating gauge pressure.
4) Calculate the mass and volume of a periodic internal network structure 204 according to any Bravais lattice type. It is expected that the choice of Bravais lattice may affect the overall optimised structure compared to other structures. Comparison studies with different Bravais lattice types can be adopted.
5) Generate the model in a finite element model simulation package modelled, in an embodiment, in the elastic regime.
6) Mesh the model and apply any relevant boundary conditions.
7) Calculate the stress and strain in all the elements in the pressure vessel, including the pressure vessel walls 202, 302 and support members 208.
8) Determine whether the outer skin 302 of the pressure vessel yields (stress above yield stress). If yield does not occur, then repeat step 4) with reduced thickness.
9) Calculate “virtual” volumes where the stress and strain is in the elastic regime and the stress is below a fraction “f” of the yield stress, where “f” is less than one.
10) Calculate “virtual volumes” where the stress and strain is above the yield stress. If there are no volumes where the stress is greater than the yield stress, then repeat from step 3) above, with a larger size support member 208 (to decrease the support member density).
11) In “virtual volumes” where the stress and strain are above the yield stress, increase the support member density by a factor “k1”, where “k1” is greater than one. The support member density may be increased by increasing the multiplication factor to the nearest integer at each applicable node of the internal network structure 204. As described above, there are other ways to increase the support member density. Any of the above ways could be used to iterate the internal network structure.
12) In “virtual volumes” where the stress and strain are above the yield stress, decrease the support member density by a factor “k2”, where “k2” is greater than one. The support member density may be decreased by decreasing the multiplication factor to the nearest integer greater than zero at each applicable node of the internal network structure 204. As described above, there are other ways to decrease the support member density. Any of the above ways could be used to iterate the internal network structure
13) Repeat from step 5) with the revised structure replacing the Bravais structure, until both the support members 208 and outer skin 302 of the pressure vessel no longer yield, and when the mass and/or volume is minimised. For the avoidance of doubt, step 12) increases the mass and decreases the volume, whilst step 13) decreases the mass and increases the volume. It is therefore expected that the mass and volume may increase or decrease with each iteration.

The invention may be summarised by the following numbered clauses:
1. An inner liner of a pressure vessel comprising the inner liner and an outer layer disposed around the inner liner, the inner liner comprising: a surface defining an enclosed volume; and an internal network structure disposed inside the enclosed volume, wherein the internal network structure comprises a plurality of connecting support members defining a continuous path. The inner liner may reduce the hoop stresses transferred into an outer layer of the pressure vessel and form an impermeable barrier to the contained gas within the pressure vessel. The inner liner incorporated into the pressure vessel may improve the gravimetric and volumetric energy densities of the pressure vessel. The internal network structure may be based on a periodic structure or non-periodic structure.
2. The inner liner of clause 1, wherein the surface of the inner liner and internal network structure define an interconnected volume for containing fluid.
3. The inner liner of any one of clause 1 to 2, wherein the continuous path comprises one or more nodes and the nodes define a point where one support member connects with at least one other support member, whereby the number of the at least one other support member defines a multiplication factor. There may be a plurality of contact points contiguous with the surface of the inner liner, at opposing sides of the inner liner, and these contact points are in mechanical communication with one another through one or more of the continuous paths.
4. The inner liner of clause 3, wherein the multiplication factor is constant. The multiplication constant may also vary.
5. The inner liner of any one of clause 1 to 4, wherein the effective stiffness of the internal network varies along the continuous path.
6. The inner liner of clause 5, wherein the variation in the effective stiffness of the internal network is controlled by varying the local number density of support members along the continuous path.
7. The inner liner of clause 6, wherein the variation in the local number density of support members is controlled by varying, in any combination, any of the following:
   i) the distance between adjacent nodes in the continuous path;
   ii) the multiplication factor of the one or more nodes; and/or
   iii) an angle between the at least one support members at each node.

As the local number density of support members may be controllable, the number of contact points on the surface of the inner liner is controllable. The number of contact points may determine the magnitude of the stress concentration which forms at these contact points for a given gauge pressure.
8. The inner liner of clause 5, wherein the variation in the effective stiffness of the internal network is controlled by varying the material composition and/or material comprising the support members.
9. The inner liner of clause 5, wherein the variation in the effective stiffness of the internal network is controlled by varying the cross sectional area of the support members.
10. The inner liner of any one of clause 5 to 9, wherein the effective stiffness of the internal network along the continuous path increases with increasing proximity to the surface of the inner liner. The effective thickness may increase in discrete steps, pseudo-continuously, or continuously from the centre of the internal network structure to a contact point on the surface of the inner liner.
11. The inner liner of any one of clause 5 to 10, wherein the effective stiffness of the internal network along the continuous path increases with increasing proximity to regions of the surface of the inner liner with a lower effective radius of curvature.
12. The inner liner of clause 10 or 11, wherein increasing the effective stiffness of the internal network along the continuous path comprises any one or more of:
   i) decreasing the distance between adjacent nodes in the continuous path;
   ii) increasing the multiplication factor of the one or more nodes;
   iii) increasing the angle between the at least one support members at each node;
   iv) increasing the fraction of the stiffer material in the composition;
   v) increasing the cross sectional area of the support members.
13. The inner liner of any one of clause 1 to 12, wherein the inner liner comprises a polymer, ceramic, metal or composite thereof. The inner liner may be a single, or integral component.
14. The inner liner of any one of clause 1 to 13, wherein the internal network structure comprises graphene as a filling material. The filling material may be used as a stiffening filler constituent.
15. The inner liner of any one of clause 1 to 14, wherein the shape of the surface is one of, a cylinder, a sphere, an oblate spheroid, an ellipsoid, a rounded cuboid, or a rounded rectangular cuboid. The shape of the inner liner may be designed to optimise the trade-off between: reducing the additional mass of the inner liner, the stress reduction in the outer layer of the pressure vessel and reducing the stress concentrations which may form on the surface of the inner liner. A computer implemented method may be adopted to optimise for this purpose. The method may be iterative. The shape of the inner liner may also be designed to fit a particular space in the operating environment.
16. A pressure vessel comprising: the inner liner of any one of clauses 1 to 15; and an outer layer disposed around the inner liner.
17. The pressure vessel of clause 16, wherein the volume for containing fluid in the inner liner comprises a compressed gas or liquid. The gauge pressure of the pressure vessel may be more than 300 bar, 350 bar, 500 bar, or 700 bar.
18. The pressure vessel of clause 17, wherein the fluid comprises one of: hydrogen, nitrogen, oxygen, natural gas, methane, ammonia, biogas, liquid hydrogen, liquid nitrogen, liquid nitrogen, liquid natural gas, liquid ammonia, and liquid methane or liquid biogas.
19. The pressure vessel of any one of clauses 16 to 18, wherein the outer layer comprises a woven carbon fibre cloth infused with resin. The fibre may be carbon fibre.
20. A method for additive manufacturing an inner liner of a pressure vessel of any of clauses 1 to 15, comprising any one of the following methods: Vat photo polymerisation; Material jetting; Binding jetting; Direct metal laser sintering; Selective laser sintering; Selective laser sintering; Multi jet fusion; Fused deposition modelling; Injection moulding; or Lost-wax casting.
21. A method for manufacturing a pressure vessel of clauses 16 to 19 with an inner liner comprising an internal network structure by applying an outer layer around the inner liner by any one of the following methods: Resin infusion; Low temperature compression moulding; Filament winding; or Vacuum assisted resin transfer moulding.
22. A computer program comprising computer executable instructions that, when executed by a processor, cause the processor to control an additive manufacturing apparatus to manufacture the inner liner of any of clauses 1 to 15.
23. A method of additive manufacturing according to clause 22, the method comprising: obtaining an electronic file representing a geometry of a product wherein the product is an inner liner according to clause 1; and controlling an additive manufacturing apparatus to manufacture, over one or more additive manufacturing steps, the product according to the geometry specified in the electronic file.

The present invention further relates to a sectional inner liner, and sectional pressure vessel comprising the sectional inner liner.

The overall size and shape of the sectional pressure vessel 100 may be varied according to operation requirements. In general, the size of the sectional pressure vessel 100 may be in the range 50 to 2000 mm and the shape of the sectional pressure vessel 100 can be, for example, configured to fit an arbitrary space in a vehicle, or, configured in shape to allow stackable arrangements. The sectional pressure vessel 100 can therefore be described as a “conformal pressure vessel”.

The sectional pressure vessel 1300 comprises an outer skin 102, and a plurality of interlocking inner liner sections 1302, 1304, 1306 that, when connected, form an outer surface 202 of the sectional inner liner 1300 disposed inside the outer skin 102. There are three types of inner liner section: a central section 1302; a cap section 1306; and an intermediate section 1304.

Each of these inner liner sections 1302, 1304, 1306 comprises at least one interlocking portion 1308, 1310, which is configured to engage with a complementary interlocking portion 1308, 1310 of an adjacent inner liner section 1302, 1304, 1306, such that inner liner sections 1302, 1304, 1306 can be mated with one another. In an example, the complementary interlocking portions 1308, 1310 respectively comprise complimentary collars/flanges portions that interlock. Other examples include tongue and groove, or teeth arrangements, or any other latching mechanism, as the skilled person would appreciate. More generally, the interlocking portions 1308, 1310 can either be described as “male” type or “female” type.

The central and intermediate inner liner sections 1302, 1304 comprise two opposing open ends, whereas the cap section 1306 comprises an open-end and a closed-end. The closed-end defines one of the sectional inner liner faces 1312. The central liner section 1302 may comprise the same type of interlocking portion 1308, 1310 (i.e., male-male or female-female) at each of its open-ends. The intermediate inner liner section 1304 comprises opposite (or complementary) types of interlocking portion 1308, 1310 (i.e., female-male or male-female) at each of its open-ends. The cap section 1306 comprise a single interlocking portion 1308, 1310 (i.e., male or female) located at its open-end. Hence, a sectional inner liner 1300 may be constructed from a central inner section 1302, two cap sections 1306 and, optionally, one or more intermediate inner liner sections 1304.

Each inner liner section 1302, 1304, 1306 comprises an internal network structure, which may be any of the structures shown in FIG. 2, 3, 8 to 12, or 15 to 16. However, it should be appreciated that these internal network structures are not intended to be limiting in any way and are provided as illustrative examples only. The specific internal network structure used in the sectional inner liner may be determined by optimisation based on operational requirements (e.g., the size and shape that the “conformal” pressure vessel conforms with). The outer surface 202 of the sectional inner liner therefore defines a volume for fluid storage. It is envisaged that the sectional inner liner is used to store hydrogen, but other fluids may be stored, for example, nitrogen, oxygen, natural gas, ammonia, biogas, methane gas, liquid hydrogen, liquid nitrogen, liquid nitrogen, liquid natural gas, liquid ammonia, liquid methane or liquid biogas. The sectional pressure vessel 1300 is configured to store fluid at high pressure, such as 300 bar, 350 bar, 500 bar or 700 bar.

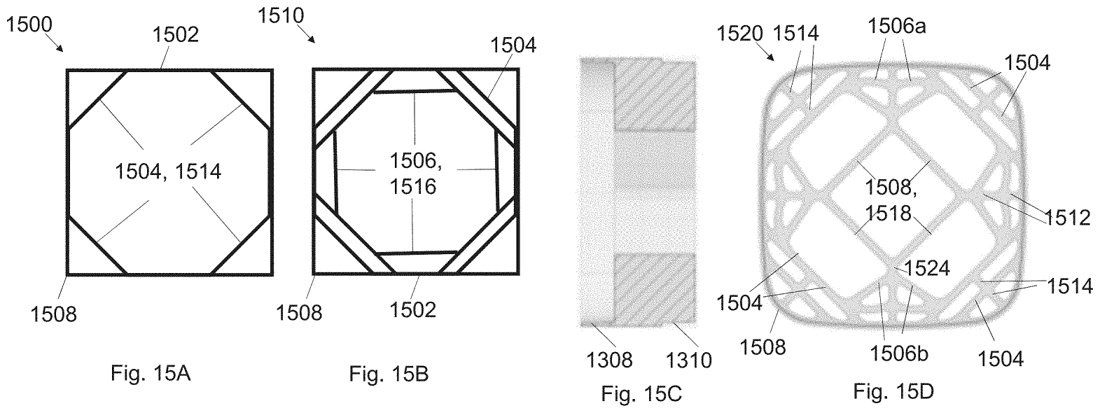

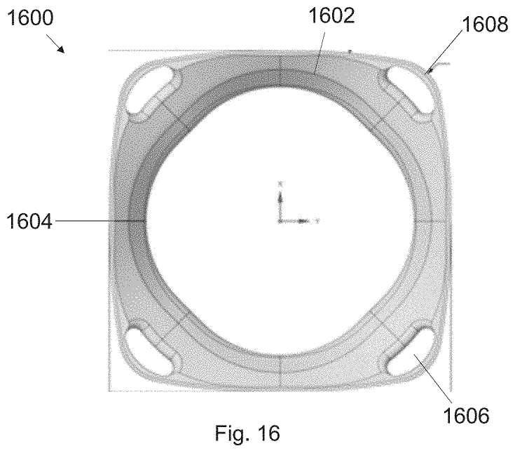

In another example (not shown), the sectional inner liner 1300 comprises two end sections 1306 without any intermediate or central inner liner section 1302, 1304. In this arrangement, the sectional inner liner 1300 resembles a split “clamshell”. The split line between each end section 1306 can either be parallel the longitudinal axis of the inner liner or orthogonal to it. Optionally, each end section 1306 comprises an internal network structure described in more detail below with reference to FIGS. 15 and 16. In the “split clamshell” example, the interlocking end portions 1308, 1310 of each end section 1306 are complementary such that they are able to mate with one another.

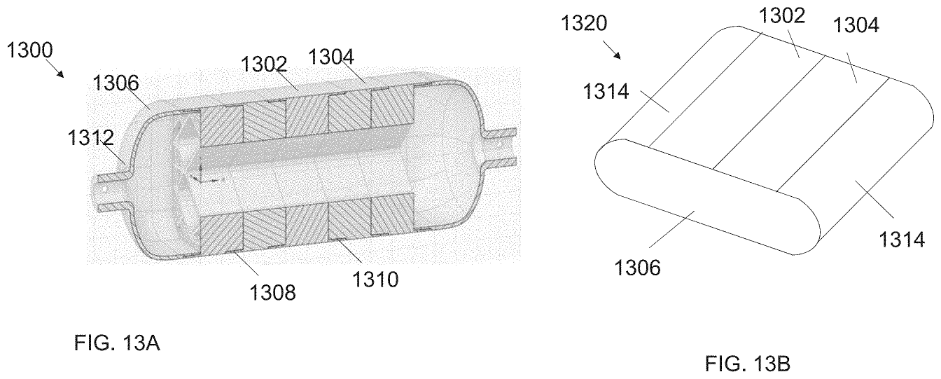

In FIG. 13A, each central and intermediate inner liner sections 1302, 1304 are adjoined with one another in a plane perpendicular to the longitudinal direction of the pressure vessel. In an alternative exemplary sectional inner liner 1320, as shown in FIG. 13B, the central and intermediate inner liner sections 1302, 1304 are adjoined in a plane containing the longitudinal direction of the pressure vessel. In this alternative example, the pressure vessel additionally comprises two further end caps sections 1314, which comprise, which adjoin an adjacent intermediate inner liner section 1304 and the end cap sections 1306, to form a closed sectional inner liner 1320.

Compared to conventional cylindrical or spherical pressure vessel designs, non-circular cross-sections (such as the rounded-square cross-section shown in FIG. 13A) are able to store a larger volume of fluid. Improvements in volumetric and/or gravimetric energy density efficiencies are therefore possible provided the fractional increase in efficiency is not outweighed by any decrease in strength associated with the non-round shape. The internal network structure, provided within each inner liner section 1302, 1304 acts as a structural support for this purpose.

Referring now to FIG. 14A, the radial deformation of a hexagonal inner liner section 1400 is shown, when internally over pressurised with fluid. The inner liner section 1400 shown in FIG. 4a does not comprise an internal network structure. The original shape of the outer surface 1402 of the inner liner 1400 is shown for clarification. The results were calculated using a commercially known software package based on a finite element analysis simulation. The results show that the edges 1408 of the inner liner section have a tendency to move towards the axial centre of the inner liner 1400 (i.e., corresponding to a negative radial deformation), whereas the centre of the faces of the inner liner section 1400 have a tendency to move outwardly away from the axial centre of the inner liner section 1400, (i.e., bow out, corresponding to a positive radial deformation). The radial deformation away from the centre of the inner liner section 1400 is greatest in the centre of each face of the outer surface 1402 of the inner liner section. The radial deformation towards the centre of the inner liner section is greatest along the edges 1408 of the inner liner section. The radial deformation varies continuously between these two positions, symmetrically around the entire inner liner section 1400. Inner liner section(s) comprising “sharp” edges 1408 therefore have a tendency to revert to a circular shape, when internally over pressurised.

FIG. 14B shows the Von Mises stress corresponding to the radial deformations shown in FIG. 14A. The stresses are calculated using commercially known software packages. The results show that the Von Mises stress is largest along the edges 1408 of the inner liner section and along the centre of each face of the inner liner. These maxima correspond with the maximum positive and negative radial deformations shown in FIG. 14A. The Von Mises stress varies continuously between these maxima and symmetrically across the entire inner liner section 1400. Preliminary results suggest that failure is located along the edges 1408 of the inner liner section. The same teaching applies to a square, or any other non-circular cross section inner liner section. Turning to FIG. 15A and FIG. 15B, a cross-sectional view of an inner liner section 1302, 1304 is shown, comprising an internal network structure 1500, 1510. In FIG. 15A, the internal network structure 1500 comprises a first set of support members 1514, comprising a plurality of first support members 1504. Each support member 1504 extends across one of the internal corners 1508 of the inner liner surface 202. The internal corners 1508 are equivalent to a corner edge in three dimensions and references to corners elsewhere in the description should be interpreted accordingly. The first set of support members 1514 therefore constrain each of the faces 1502 of the inner liner section 1302, 1304, which has the effect of reducing their tendency to bow outwards (as shown in FIG. 14A, 14B). The first set of support members 1514 therefore serve to reduce or distribute the stress and strain from each of the faces 1502 of the inner liner to the internal network structure (in particular, from the centre of each face 1502). The stress and strain are therefore distributed over a larger area, which reduces stress concentrations, premature failure and enables higher storage pressures within the pressure vessel.

In the example shown in FIG. 15A, the inner liner is square in cross-section and the corner-extending support members 1504 are arranged at 45 degrees relative to each face 1502. More generally, the corner-extending support members 1504 may be arranged at an angle equal to half the internal angle of the inner liner surface 202, relative to each face 1502.

In FIG. 15B, the internal network structure 1510 comprises:
a first set of support members 1514 as shown in FIG. 15A; and
a second set of support members 1516, comprising a plurality of second support members 1506. Each support member 1506 extends between two first support members 1504, which extend across adjacent corners 1508 of the inner liner.

The second set of support members 1516 therefore constrain the first support members 1504, thereby reducing their tendency to bow outwards (in a similar way to shown in FIG. 14A, 14B). In turn, the first set of support members constrain faces 1502 of the inner liner. In this way, stress and strain may be effectively distributed from the inner liner face 1502 to a larger area of internal network structure 1510. Hence, stress concentrations can be reduced further, enabling even higher storage pressures and the potential for improved gravimetric storage efficiencies.

On the other hand, including further support members to the internal network structures reduces the total volume within which fluid may be stored under pressure. There is an optimisation to the number of support member sets, which maximises the gravimetric efficiency of the sectional pressure vessel.

FIG. 15C shows a longitudinal cross section of an optimised internal structure for an inner liner section. The inner liner section comprises interlocking portions 1308, 1310 and an internal network structure 1520. As shown, the cross section of the internal network structure 1520 is constant along the longitudinal axis of the inner liner section. That is, the internal network structure 1520 could be readily extruded using a die or injection moulded using a split tool.

FIG. 15D shows a transverse cross section of an optimised internal network structure 1520 for an inner liner section. The optimised internal network structure 1520 comprises:
a first set of support members 1514, comprising a plurality of first support members 1504, wherein each support member 1504 extends across one of the internal corners 1508 of the inner liner surface 202;
a second set of support members 1516, comprising a plurality of second support members 1506a, 1506b, wherein each support member 1506a, 1506b extends between two first support members 1504 that extend across adjacent corners 1508 of the inner liner;
a third set of support members 1518, comprising a plurality of third support members 1508, wherein each support member 1508 extends between two adjacent second support members 1506b and forms a square;
a fourth set of support members 1522, comprising a plurality of fourth support members 1512, wherein each support member 1512 extends in a radial direction between the centre of each face 1502 of the inner liner section and a vertex of the square formed by the third set of support members 1518. Optionally, the support member 1512 may bisect one or more of the second support members 1506a, 1506b; and
a fifth set of support members 1524, comprising a plurality of fifth support members 1514, wherein each support member 1514 extends in a radial direction between the internal corner 1508 of the inner liner and one or more of the first support members 1504. Optionally, the support member 1514 may bisect one or more of the first support members 1504.

In the example shown in FIG. 15D, the third set of support members 1518 form a square, with its vertices 1524 pointing towards the centre of each face 1502 of the inner liner section. More generally, if the shape of the outer surface 202 of the inner liner section is axially symmetric, then the shape formed by the third set of support members 1518 may be substantially similar to the shape defined by the outer surface 202 of the inner liner section.

The fourth and fifth set of support members 1522, 1524 provide radial support to the second and first set of support members respectively. As has already been noted, the first 1504 and second support members 1506a, 1506b have a tendency to bow outwards (although this tendency is reduced by the second set of support members and third set of support members respectively). For the first and second support members 1504, 1506a, 1506b to bow outwardly, the radially extending support members 1512, 1514 must be compressed. Hence the fourth and fifth set of support members 1522, 1524 constrain the second and first set of support members respectively to reduce the maximum stress in the first and second set of support members 1514, 1516. In this way, the stress and strain are distributed more evenly over a larger area.

Referring now to FIG. 16, an alternative internal network structure 1600 is shown. The internal network structure 1600, instead of being disposed within a volume defined by the outer surface 202 of the inner liner, is integral formed within a thickness of the inner liner wall 1602. The internal network structure comprises an inner liner wall 1602 of variable thickness. More particularly, the inner liner wall 1602 is thickest along the corner edges 1608 and thinnest along the centre of each of the inner liner section faces and varying monotonically in-between. Preferably, the thickness variation defines an internal volume with a shape, in cross section, substantially similar to the outer surface 202 of the inner liner section wall. The internal network structure 1600 comprises one or more holes 1606, which are located along each corner edge of the inner liner section. The one or more holes 1606 may be partially circumferential.

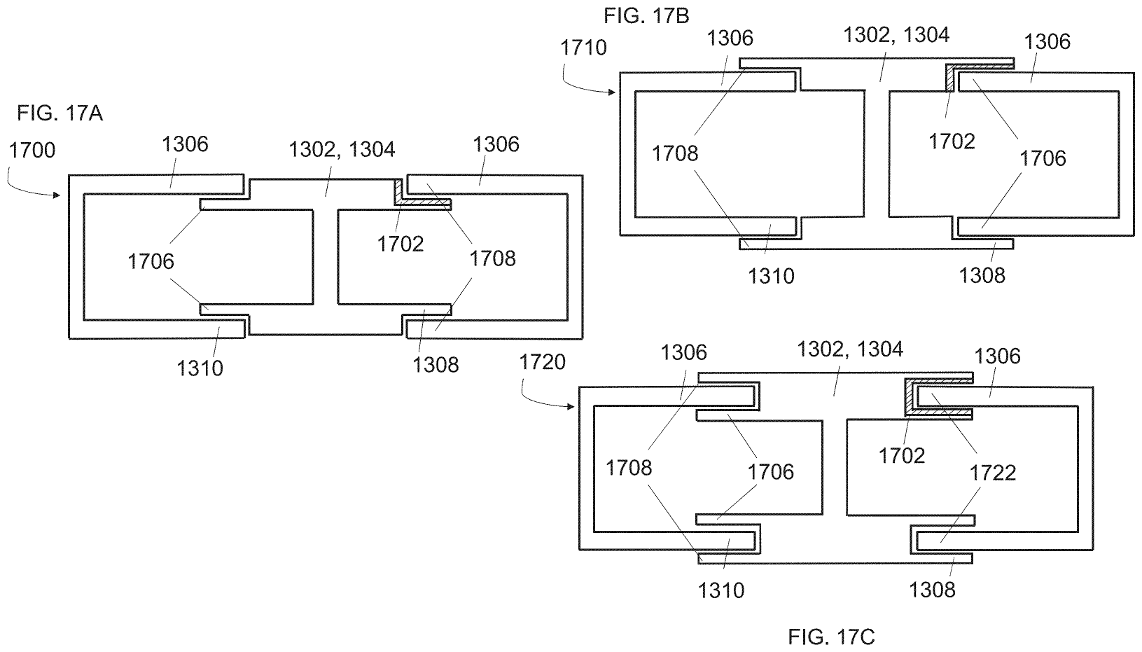

FIG. 17A shows an exemplary flange connection 1700, comprising complementary interlocking portions 1308, 1308 of the inner liner sections 1302, 1304, 1306. The interlocking portions 1308, 1310, when mated, define a sealing surface 1702 (i.e., a flange, a portion of which is denoted in FIG. 17A as a hashed area, between adjacent inner liner sections 1302, 1304, 1306 in which the aforementioned joining methods can be applied). Equivalently, the intermediate or central inner liner section 1302, 1304 in FIG. 5A comprises an internal collar 1706. The interlocking portion 1310 of the end cap inner liner section 1306, when mated with the interlocking portion 1308 of the adjacent inner liner section 1302, 1304, defines an external collar 1708, thereby forming the sealing surface 1702.

FIG. 17B shows an alternative flange connection 1710 between inner liner sections 1302, 1304, 1306. The flange connection 1710 is equivalent to that shown in FIG. 17A, except the intermediate or central inner liner sections 1302, 1304 comprise an external collar 1708. Hence, interlocking portion 1310 of the end cap inner liner section 1306, when mated with the interlocking portion 1308 of the adjacent inner liner section defines an internal collar 1706 thereby forming the sealing surface 1702.

FIG. 17C shows a further flange connection 1720 between inner liner sections 1302, 1304, 1306. In the flange connection 1720, the intermediate or central inner liner sections 1302, 1304 comprise both an internal 1706 and an external collar 1708, which defines a recess. The interlocking portion 1310 of the end cap inner liner section 1306, when mated with the interlocking portion 208 of the adjacent inner liner section 1302, 1304 defines “teeth” 1722, thereby forming the sealing surface 1702.

In FIG. 17A to 17C, the sealing surface 1702 comprises one step 1704, however, in some examples, there may be a plurality of steps. In this regard, the interlocking portions 1308, 1310 of the inner liner sections 1302, 1304, 1306 may comprise a plurality of complementary steps. A sealing surface 1702 comprising a stepped profile defines a tortuous path for fluid to escape the sectional pressure vessel 1300, thereby reducing propensity of leaks and improving the seal strength by increasing the total surface area of the seal. In an example, the collar length may be 25 mm.

### Materials

The (sectional) inner liner 200, 1300 may comprise a thermoplastic or thermoset polymer. For example, high density polyethylene (HDPE), polyaryletherketone (PAEK), polyether ether ketone (PEEK), nylon (e.g., PA6, PA12), an epoxy, or a blend thereof.

In some examples, the internal network structure 204, 500, 800, 900, 1000, 1100, 1200, 1500, 1510, 1520 of the (sectional) inner liner 200, 1300 may comprise additives. These additives, or fillers, may be functional and/or structural. In an example, nano-fillers such as graphene, carbon fibre (e.g., in the form of short, “chopped” fibres), and/or carbon nano-tubes are added to improve the stiffness and yield stress of the internal structure 204, 500, 800, 900, 1000, 1100, 1200, 1500, 1510, 1520. In some examples, the internal network structure may comprise additives of lightweight metals such as Aluminium, or aluminium alloys, titanium or titanium alloys, or ceramics e.g. alumina. In this way, the internal network structure may comprise a polymer-metal composite or a polymer-ceramic composite. As described above, in some examples, a gradient in stiffness can be engineered by varying the stiffness of the support members 208, 502. One option for generating this varying stiffness is to vary the volume or mass fraction of this structural additive.

In other examples, the internal network structure 204, 500, 1500, 1510, 1520 may be a lightweight metal or ceramic. A non-exhaustive list of possible metals includes aluminium and aluminium alloys. A non-exhaustive list of possible ceramics includes alumina.

In other examples, hydrogen absorbing, or adsorbing additives can be added to the internal network structure 204, 500, 800, 900, 1000, 1100, 1200, 1500, 1510, 1520. In this way, the effective volume 206 for containing pressurised gas can be increased. In response to a pressure drop, these hydrogen absorbing/adsorbing additives are configured to controllably release hydrogen.

In some examples, the outer surface 202 of the (sectional) inner liner 200, 1300 also comprises structural additives. It is envisaged that the outer surface 202 of the inner liner 200 is thin and therefore preferably the additive does not affect the permeability of the outer surface 202 of the inner liner 200 to the contained gas.

In examples where the pressurised gas is hydrogen, the material comprising the (sectional) inner liner 200, 1300 is not susceptible to hydrogen embrittlement. More generally, the material of choice may depend on a combination of additional factors, such as: material cost, density, stiffness and yield stress of the material. The use of an Ashby chart for selecting a material based on the optimisation of specific stiffness or equivalent, is known to the skilled person.

In the bubble or foam internal network structure 1100, the internal body 1102 may comprise a foamed thermoset, or a metal foam, or a ceramic foam. The thermoset may be an epoxy. The metal may be a lightweight alloy of aluminium or titanium. The ceramic may be alumina, zirconia, or other lightweight ceramic. In the above examples, complimentary foaming agents for each material may be included to facilitate the foaming process.

The outer skin 302 of the pressure vessel 300, 700 may comprise a filament or tape wound thermoset fibre reinforced composite (FRC), compression moulded FRC or a resin infusion or vacuum assisted resin transfer moulding (VARTM) of a thermoset in a carbon fibre pack. The filament or tape may comprise carbon fibre (e.g., pitch-based carbon fibre, or T1000), aramid or boron fibres. The resins may comprises any of epoxies, cyanate esters, polyurethane, polyester, vinyl ester, phenolics, furans or polyamides.

### Mode of Manufacture

The mode of manufacture of the pressure vessel 200, 700 comprises four main steps. The sectional pressure vessel 1300 further comprises a joining step, as set out below.

i) Structural Optimisation

The first step is simulation-based optimisation of the internal network structure to minimise the mass for a given shape and internal operating gauge pressure. The optimisation may be based on iterative techniques. Other forms of optimisation are possible, e.g., gravimetric and volumetric energy densities. Equivalently, as set out in detail above, a structurally optimised internal network structure improves redistribution of stress from areas of “higher” stress in the internal network structure to areas of “lower” stress, thereby homogenising the stress in the inner liner elements to avoid premature failure at stress concentrations. The stress imposed in the overwrap and surface of the inner liner are thereby reduced.

ii) Manufacture of Inner Liner 200 or Inner Liner Sections 1302, 1304, 1306

In the second step, the optimised inner liner 200 (with internal network structure 204, 500, 800, 900, 1000, 1100, 1200) may be manufactured by a method of additive manufacturing. In other examples, the method of manufacture may be a conventional process such as net-shape forming. In other examples, the method of manufacture may be a subtractive method. In some of these examples, the method of manufacture may comprise a foaming agent.

The inner liner sections 1302, 1304, 1306 may be manufactured by additive manufacturing, injection moulding or casting. One or more valve ports may be added to each inner liner end section 1306, using manufacturing techniques known to the skilled person.

### Additive Manufacturing

The exact choice of additive manufacturing is at least partially dependent on the material selection of the inner liner 200. A non-exhaustive list includes: stereolithography methods (Vat photopolymerisation), material jetting, binder jetting, powder bed fusion (Direct metal laser sintering (DMLS), selective laser sintering (SLS), selective laser melting (SLM), multi jet fusion (MJF), electron beam melting (EBM)), filament extrusion processes (fused deposition modelling (FDM). A non-exhaustive list of net-shaped manufacturing methods includes injection moulding, lost-wax casting or investment casting.

### Injection Moulding

In some examples, the internal network structure may be manufactured using injection moulding. This mode of manufacture may be particularly advantageous for large internal network structures 204, 500, 800, 900, 1000, 1200 where additive manufacturing routes are impractical, or time consuming. A large internal network structure 204, 500, 800, 900, 1000, 1200 is one comprising dimensions greater than 500 mm. For example, in FDM, the size of the component is limited by the range of the rastering device and the size of the heated bed, which is typically less than 500 mm. The sectional inner liner sections 1302, 1304, 1306 may also be produced by injection moulding. In particular, using split moulding techniques.

### Extrusion

In some examples, the intermediate and/or central inner liner sections may be formed by extrusion. The interlocking portions 1308, 1310 may then be produced by any subtractive manufacturing technique known to the skilled person.

### Subtractive Manufacturing

The internal network structures 1200 may be produced by selectively removing material, rather than through additive manufacturing routes. In some examples, the internal network structure 1200 may be manufactured by drilling holes in plates 502 which are produced by an injection moulding process. Such subtractive manufacturing methods include CNC (computer numeric control) of drills, lathes, and the like.

### Foaming Process

In some examples, the internal network structure 1100 may form a foam. The foam may be manufactured by a foaming process route, which results in an open celled structure. The foaming process route may include a foaming agent. For polymeric materials, the foaming agent may be a chemical agent. The chemical agent may be used both to synthesis the polymer and to generate gas as a by-product in the reaction. In other examples, the foaming agent may comprise an inert gas such as Argon. In the latter, the local flow rate of the gas may be controlled spatially to generate regions of increasing or decreasing bubble density, such that the foam density varies from low density, or larger bubble diameters, at the core and decreases towards the outer surface 202 of the inner liner 200 to produce progressively smaller bubbles. The foaming agents may be included in combination with any applicable additive manufacturing route. Furthermore, the foam may be generated in a moulding process and therefore may also form a preparation step in a subtractive manufacturing method.

iii) Joining the Inner Liner Section to Form a Sectional Inner Liner

In the sectional inner liner approach, the manufactured inner liner sections 1302, 1304, 1306 are joined by mating complementary interlocking portions 1308, 1310 and sealing the sealing surface 1702 using adhesive bonding or welding. Adhesive bonding is applicable to both polymer-based and metal-based inner liner sections 202, 204, 206, 400. Welding is applicable for metallic inner liner sections 202, 204, 206, 400. Other joining methods known to the skilled person are also applicable.

iv) Applying Outer Skin (the Overwrap) 302

In the third step, the outer skin 302 of the inner liner 200 or sectional inner liner is overwrapped with a carbon fibre reinforced resin composite, or other reinforcing fibre. In some examples, the carbon fibre reinforced resin is applied using a filament winding method. The wind angle and tension can be controlled using appropriate machinery known to the skilled person. Alternatively, the outer skin 302 may be applied by braiding the filaments, infusing the braid with resin and curing under vacuum. Automated fibre placement may also be used to apply the overwrap. Options include: filament wound dry fibre/tape preform for resin impregnation, or pre-impregnated fibre/tape towpreg.

In other examples, pre-prepared woven carbon fibre cloth can be applied and bonded with the outer surface 202 of the (sectional) inner liner 200, 1300 using a resin infusion process or a low temperature compression moulding process. In the latter, an autoclave is used to bond two pre-impregnated skins of the pre-prepared woven carbon fibre cloth together in a curing process. In some examples, the carbon fibre cloth may be replaced with any of the filament or tape materials described above.

An advantage of the sectional inner liner approach is that the length of the sectional inner liner 1300 can be tuned according to operational requirements, and is not (unlike conventional inner liner) limited to the physical size of manufacturing equipment. Furthermore, for casting and injection moulding routes, only a finite number of moulds are required to produce an inner liner 1300 of arbitrary length.

v) Gas Valve Integration

During manufacture of the inner liner by injection moulding or additive manufacturing, a metallic valve port, such as a polar boss for a gas inlet/outlet, may be included by over-moulding or insert moulding.

One or more valves can be integrated into the end sections 1306 of the pressure vessel 300, 700, 1300. In the sectional approach, the one or more valves are optionally moulded-in with the end sections 1306 during injection moulding. Alternatively, the one or more valves can be fitted prior to or after the overwrapping step stage, using methods known to the skilled person.

The contained fluid in the pressure vessel may be hydrogen, nitrogen, oxygen, methane, natural gas, ammonia, biogas, liquid hydrogen, liquid nitrogen, liquid nitrogen, liquid natural gas, liquid ammonia, liquid methane, or liquid biogas.

The invention has been described in detail with reference to the exemplary embodiments; modifications may be made without departing from the scope of the invention as defined by the claims. Each feature disclosed or illustrated in the present specification may be incorporated in the invention, whether alone or in any appropriate combination with any other feature disclosed or illustrated herein.

1. A sectional inner liner of a pressure vessel comprising the sectional inner liner and an outer layer disposed around the sectional inner liner, the sectional inner liner comprising:
at least two inner liner sections, wherein each of the at least two inner liner sections comprises an internal network structure; and
at least two cap sections,
wherein, the at least two cap sections and the at least two inner liner sections are configured to assemble into the sectional inner liner.

2. The sectional inner liner according to claim 1, wherein each of the at least two inner liner sections and the at least two cap sections is a single moulding.

3. The sectional inner liner of claim 1, wherein a cross-sectional shape, defined by an outer surface of one of the at least two inner liner sections, is one of a square or a rounded square.

4. The sectional inner liner of claim 3, wherein the internal network structure comprises:
a first set of support members comprising a plurality of first support members, wherein each of the first support members extends across an internal corner of a corresponding inner liner section.

5. The sectional inner liner of claim 4, wherein the internal network structure further comprises:
a second set of support members comprising a plurality of second support members, wherein each of the second support members extends between two of the first support members that extend across adjacent corners of the corresponding inner liner section.

6. The sectional inner liner according to claim 5, wherein the internal network structure further comprises:
a third set of support members comprising a plurality of third support members, wherein each of the third support members extends between two adjacent second support members to form a square, or rounded square in cross section.

7. The sectional inner liner according to claim 6, wherein the internal network structure further comprises:
a fourth set of support members comprising a plurality of fourth support members, wherein each of the fourth support members extends radially between a face defined by an internal surface of the corresponding inner liner section and a vertex of the square, or the rounded square formed by the third set of support members.

8. The sectional inner liner according to claim 7, wherein each of the fourth support members in the fourth set of support members bisects one or more of the second support members.

9. The sectional inner liner according to claim 8, wherein the internal network structure further comprises:
a fifth set of support members comprising a plurality of fifth support members, wherein each of the fifth support members extends radially between an internal corner of the corresponding inner liner section and one or more of the first support members.

10. The sectional inner liner according to claim 9, wherein each of the fifth support members in the fifth set of support members bisects one or more of the first support members.

11. The sectional inner liner according to claim 1, wherein the internal network structure is integrally formed within a thickness of an inner liner section wall of the at least two inner liner sections.

12. The sectional inner liner according to claim 11, wherein the thickness of the inner liner section wall is largest along its corner edges and smallest along a centre of each of its faces.

13. The sectional inner liner according to claim 11, wherein a variation in thickness of the inner liner section wall defines an internal volume with a shape, in cross section, substantially similar to an outer surface of the inner liner section wall.

14. The sectional inner liner according to claim 11, wherein the internal network structure comprises one or more holes located along each corner edge of one of the at least two inner liner sections.

15. The sectional inner liner according to claim 14, wherein the one or more holes are partially circumferential.

16. A pressure vessel comprising:
the sectional inner liner of claim 1; and
an outer layer disposed around the sectional inner liner.

17. The pressure vessel of claim 16, wherein the outer layer comprises a woven carbon-fibre cloth infused with resin, or a carbon-fibre winded overwrap.

18. A method for manufacturing the sectional inner liner of claim 1, comprising:
injection moulding or casting the at least two inner liner sections and the at least two cap sections; and
assembling said sections together.
